(19) United States
(12) Patent Application Publication
(10) Pub. No.: US 2026/0225110 A1
(43) Pub. Date: Aug. 6, 2026

(54) OPTIMIZED FLOUR MILL SYSTEM WITH IMPROVED MILLING YIELD AND METHOD THEREOF

(71) Applicant: Bühler AG, Uzwil (CH)

(72) Inventors: Federico AMATO, Lausanne (CH); Ali BAAJOUR, Lausanne (CH); Matthias GRÄBER, St. Gallen (CH); Tom HEINTEL, Konstanz (DE); Amalia SPATARU, Lausanne (CH); Peter STRIEGL, Hauslenen (CH)

(73) Assignee: Bühler AG, Uzwil (CH)

(21) Appl. No.: 19/149,158

(22) PCT Filed: Jan. 22, 2024
(86) PCT No.: PCT/EP2024/051443

§ 371 Date: Jul. 18, 2025

(30) Foreign Application Priority Data
Jan. 23, 2023 (EP) 23152934.8

(51) Int. Cl. B02C 25/00; B02C 4/06

(52) U.S. Cl. CPC B02C 25/00; B02C 4/06

(57) ABSTRACT

A system, method and device for improving milling yield of a flour milling machine is disclosed. The system includes a first processing unit for receiving, from an operation data storage, a historical flour milling machine operations data. The system includes a modelling engine of the first processing unit for generating at least one machine learning model structure to determine a target moisture based on historical flour milling machine operations data using machine learning. The system includes a water dosing controller of a flour milling machine that receives the target moisture and adds moisture to the grains based on the target moisture.

### FIELD OF THE INVENTION

The present invention relates to devices, systems, and methods for improving yield of milling machines by optimizing flour mill. In addition, it relates to devices, systems, and methods for generating dampening control that can be tested, benchmarked, and selected in a virtual environment (modelling structure, digital twin representation) before deploying the best or otherwise selected one in a real mill. The tempering process is a sensitive key process in wheat flour milling that technically requires proper adjustments to achieve a desired level of flour quality and yield. The present invention provides an automated system enabled to predict the moisture content of wheat at the end of tempering and to optimize steering of the flour mill. In general, the present invention relates to an intelligent, self-adaptive regulation and control device for the automated regulation and control of milling systems as grinding and roller systems, in particular mill installations with a roller mill, but also mill systems and grinding installations in general.

### BACKGROUND OF THE INVENTION

Milling, in particular grain milling, is also referred to as an art. Unlike in other areas of industry, in which the influence of the various factors that determine the dynamics of a process is mostly well known, and in which the relevant processes can therefore be easily parameterized using appropriate equations and formulas or the apparatus and device involved is simply controlled and regulated accordingly, the number of relevant factors that influence the grinding quality and also the yield of the processed final product is extraordinarily high in the milling industry. It is therefore often necessary for a miller, as human expert, to manually adjust and set the entire grinding or milling installation following analysis of the starting/raw material based on his intuition and know-how in order to obtain the best possible results in terms of the expected quality and yield of the final product (e.g. ash content, yield, baking quality, etc.). All this while minimizing costs, i.e. in particular, energy efficiency. It should also be noted that the grinding properties of the starting material, e.g. the ground wheat or grain, are fundamental for the grinding process. Since the grinding installation must typically be regulated by the head miller, the head miller also has decisive influence on and control of the characteristics of the produced flour. This starts with the choice of the wheat class, which can refer to both the market class and to the place or region of production of the wheat, to influence certain grain attributes such as a certain protein range. The miller also controls the wheat blend/grists, which are added to the grinding installation. The miller can also measure the mill flow, roller speed, speed differentials, distribution of the fluted rollers, e.g. sharp-to-sharp, and roller pressure in the case of smooth rollers. The miller has additional regulation options in combination with sieving and cleaning and finally in the grinding current selection for mixing the final flour produced. All these parameters and regulation options are used by the miller to consistently produce flour of a certain quality.

Flour milling, as one particular milling process, is a process where grains are added into a flour milling machine to obtain flour from the grains. Wheat is one of an important and primary grain used for consumption across the world. Wheat flour is used for making bread, tortillas, and such consumable dishes that are consumed almost daily in the world. To obtain wheat flour, the wheat is prepared and grinded in the flour mill. For the preparation of the wheat for milling, the wheat grains are first cleaned to remove wheat straws, unwanted grains, and any other waste materials. Water is added to the cleaned raw wheat in a cleaning section of a flour mill and kept for some time. Water is added with an objective to reach a defined moisture target value of the grain which yields optimal milling conditions. Adding water and keeping it for a defined amount of time is called as conditioning. The conditioning process is a continuous process. After addition of the moisture, the wheat is kept for a defined period of time in tempering bins for a time of typically 8-24 hours (also referred to as conditioning). Post the defined period of time, the moisture wheat is processed into flour by the flour milling machine. Current flour milling is a time-consuming process requiring 6-12 hours to prepare the grains, mill the grains and obtain the flour.

Currently, the flour mills are operated manually and depend on workers' expertise and experience in processing the wheat grains to flour. Also, as a part of modernization and market demands, the flour mills are expanding and there is an increasing pressure to optimize the milling performance to generate maximum achievable yield. Optimal milling performance hereby can be defined as one or a combination of following influence factors, providing significant commercial benefit for a flour producer: (i) Maximum achievable milling yield, while complying with quality specifications; (ii) Maximum achievable flour production rate based on flow rate of wheat into the milling section, while complying with quality specifications; and (iii) Moisture of flour consistently as close as possible to a target value set by quality specifications.

In addition to moisture, there are multiple factors that influence the milling performance, which includes but are not limited to: (i) Type of wheat; (ii) Type of flour to be produced and quality specifications; (iii) Ambient conditions (temperature, humidity, pressure) at time of conditioning and milling; (iv) Grain temperature; (v) Process settings in the milling section (e.g., roller mill gaps, roller wear, sifter sieve configuration and such configurations); (vi) Moisture of raw wheat; (vii) Moisture of conditioned wheat (wheat mixed with moisture for a defined period of time) when entering the flour milling machine; and (viii) Duration of conditioning of the wheat, and varying time lag between dampening and milling.

Due to the multitude of the influencing factors, non-linear relationships between the influencing factors, time lag between the conditioning and milling, a lack of an automated control solution, and a lack of a simple model due to highly non-linear dependencies, it may not be possible for the flour mill operator to control the amount of moisture, so that milling performance is at an optimum at any time. Instead, the flour mill operators strongly rely on their experience and use more static adjustments of the moisture addition, e.g., based on the season of the year, which may be error prone as ambient conditions in the flour mill may change. In practice, most of the flour mills use non-optimized dampening conditions, resulting in lower flour output and increased wheat usage per ton of flour.

From an environmental perspective, the flour mills leave some carbon footprints. Suboptimal production of flour may lead to more power consumption and in turn increase the carbon footprint. Due to the large number of flour mills globally, the suboptimal productions may have significant negative global impact of the order of several million tons of carbon emissions annually. Also, the suboptimal production may lead to more raw material per ton of flour and their associated costs.

So far, some research has been performed with flour milling trials to support domain expertise of expert operators. However, the trials cannot capture all possible variations of influencing factors. Also, trails cannot be continuously performed to capture all seasonal effects. Furthermore, there are scaling issues when using knowledge of trails by transitioning learned practice from lab/controlled conditions to production environment.

There have been some control strategies developed based on using feedback from flour to improvise the production. However, due to lags as a result of the conditioning time of 8-12 hours, which can be longer than an entire flour milling operation, led to change in other influencing factors. Also, in this time window, an optimal setpoint may have already changed again due to variation of ambient conditions and/or change of milling recipe. As a result, these control strategies are not used in practice.

As a result, there is need to improve the performance of the flour mills to maximize the achievable milling yield leading to increased or maximized productivity of the flour mills.

### SUMMARY OF THE INVENTION

It is one object of the present invention to provide a milling control system with improved milling yield of a flour milling machine to obtain optimized milling yield and raw material usage. In particular, the system should be enabled to automatically achieve a desired level of flour quality at maximum yield by proper and automated adjustments of the tempering process as a key process in the wheat flour milling. Further, the system should provide automated and precise forecast and prediction of the moisture content of the wheat at the end of the tempering process or at the end of each stage of the tempering process.

According to the present invention, these objects are achieved, particularly, by the features of the independent claims. In addition, further advantageous embodiments can be derived from the dependent claims and related descriptions.

According to the present invention, the above-mentioned objects related to a milling system for improving milling yield of a flour milling machine to obtain optimized milling yield of flour by an optimized milling process for grains as raw material to be processed by the milling machine are achieved, particularly, in that the system comprises a flour milling machine comprising an electronic controller, a water dosing unit, an operations data storage for storing historical flour milling machine operations data, and a first processing unit coupled to the operations data, in that the first processing unit comprises a machine interface for receiving historical flour milling machine operations data from the operations data storage, and a machine-learning-based modelling engine for generating at least one digital model structure based on historical flour milling operation data, the historical flour milling machine operations data at least comprise historical raw material and/or operational and/or environmental characteristics parameter values of a flour milling machine, and the digital model structure being trained by applying the historical flour milling machine operations data as input values, wherein the raw material and/or operational and/or environmental characteristics parameters at least comprise types of grains and/or temperature of the grains and/or moisture of the grains and/or duration of conditioning and/or moisture in conditioned grains and/or flour specifications and/or ambient conditions at the flour milling machine and/or flour milling machine settings and/or types of flours produced from the grains and/or yield of the flour milling machine, and, after training, for determining for a given set of flour milling operations data the optimized milling yield as maximum yield using the one or more machine learning model structures by generating a target moisture for a given set of flour milling operation data using the at least one digital model structure for obtaining maximum flour yield, the target moisture being transmitted to the controller, and in that a water dosing unit comprising a water dosing controller for receiving the target moisture, and adjusting moisture to the grains based on the target moisture during production of the by the flour milling machine. “Historic” means in the context of this application “measured in the past and accessibly recorded”.

In an embodiment variant, the digital model structure can e.g. capture non-linear dependencies between types of grains, temperature of the grains during milling, moisture in the raw grains dampening time to condition the grains, moisture in conditioned grains, flour consistency specifications, ambient conditions at the flour milling machine, flour milling machine settings, types of flours produced from the grains, and yield of the flour milling machine and determine the target moisture to generate maximum yield using the one or more machine learning model structures.

The system can e.g. further comprise a second processing unit, coupled to the first processing unit and the flour milling machine. The second processing unit includes a second machine interface for receiving ambient conditions at the flour milling machine from an input source, a type of grain and a value of moisture in the grains, and a second processing unit for executing the at least one machine learning model structure to generate an optimal control strategy to determine the target moisture, based on the ambient conditions and the value of moisture in the grains.

The flour milling machine operations data includes types of grains, temperature of the grains during milling, moisture in the raw grains, dampening time to condition the grains, moisture in conditioned grains, flour consistency specifications, ambient conditions at the flour milling machine, flour milling machine settings, types of flours produced from the grains, and yield of the flour milling machine for the grains at different temperatures, different moisture levels, different dampening periods, different ambient conditions and different flour milling machine settings, wherein the flour milling machine settings comprise roller mill gaps, sifter sieve configuration, and roller wears

The flour milling machine can e.g. comprise a manufacturing execution unit to enable adjustment of moisture addition setpoints.

The system includes a data exchange repository coupled to the first processing unit and the flour milling machine for exchanging data associated with the operation of the flour milling machine, logging the data and storing the one or more machine learning model structures.

A method for improving milling yield of a flour milling machine to obtain optimized milling yield and raw material usage, including receiving, from an operation data storage, a historical flour milling machine operations data, generating, by a modelling engine of a first processing unit, at least one machine learning model structure to determine a target moisture based on historical flour milling machine operations data using machine learning, training the digital model structure with a training data to determine an influence of moisture levels among influencing factors on flour yield, wherein the influencing factors comprise types of grains, temperature of the grains, moisture in the raw grains, duration of conditioning to condition the grains, moisture in conditioned grains, flour consistency specifications, ambient conditions at the flour milling machine, flour milling machine settings, types of flours produced from the grains, and yield of the flour milling machine and determine the target moisture to generate maximum yield using the one or more machine learning model structures, wherein the training data comprises instances from historical flour milling machine operations data having the influencing factors, determining a target moisture for a given set of influencing factors using the at least one digital model structure for obtaining maximum flour yield; communicating the target moisture to the controller and receiving, by a water dosing controller, the target moisture, and adding moisture to the grains based on the target moisture.

Other embodiment variants and advantages of the inventive system and/or method will become apparent from the following detailed description, taken in conjunction with the accompanying drawings, which illustrate by way of example the teachings of the disclosure, and are not restrictive.

### BRIEF DESCRIPTION OF THE DRAWINGS

The present invention will be explained in more detail below relying on examples and with reference to these drawings in which:

FIG. 1A shows a block diagram, schematically illustrating an exemplary architecture of a system for improving milling yield of a flour milling machine to obtain optimized milling yield and raw material usage, according to one or more embodiments.

FIG. 1B shows a block diagram illustrating generation of a digital model structure, according to one or more embodiments.

FIG. 2 shows an analysis of various factors that influence a production of wheat flour in a flour milling machine and their relative importance, according to one or more embodiments.

FIG. 3 shows a graph illustrating performances of a digital model structure on test set, according to some embodiments.

FIG. 4 is an exemplary graph illustrating a result of execution of a global approach policy by the digital model structure, according to some embodiments.

FIG. 5 is an exemplary table illustrating a result of a temperature-controlled approach policy by the digital model structure, according to some embodiments.

FIG. 6 is an exemplary graph illustrating a result of test instances indicating performance increase for nine (9) recipes for the temperature-controlled approach policy, according to some embodiments.

FIG. 7 is an exemplary histogram of a digitally modelled performance increase in an optimistic, a pessimistic and a mean scenario, based on two years of data from an industrial flour milling machine, according to some embodiments.

FIG. 8 is an exemplary graph illustrating flour yields for recipe 1 at different moisture values along with actual and modeled, by a digital modelling representation, optimal moisture target for a maximum flour yield, according to some embodiments.

FIG. 9 is an exemplary graph illustrating flour yields for recipe 2 at different moisture values along with actual and digitally modeled optimal moisture target for a maximum flour yield, according to some embodiments.

FIG. 10 is an exemplary graph illustrating flour yields for recipe 3 at different moisture values along with actual and digitally modeled optimal moisture target for a maximum flour yield, according to some embodiments.

FIG. 11 is an exemplary graph illustrating flour yields for recipe 4 at different moisture values along with actual and digitally modeled optimal moisture target for a maximum flour yield, according to some embodiments.

FIG. 12 is an exemplary graph illustrating flour yields for recipe 5 at different moisture values along with actual and digitally modeled optimal moisture target for a maximum flour yield, according to some embodiments.

FIG. 13 is an exemplary graph illustrating flour yields for recipe 6 at different moisture values along with actual and digitally modeled optimal moisture target for a maximum flour yield, according to some embodiments.

FIG. 14 is an exemplary graph illustrating flour yields for recipe 7 at different moisture values along with actual and digitally modeled optimal moisture target for a maximum flour yield, according to some embodiments.

FIG. 15 is an exemplary graph illustrating flour yields for recipe 8 at different moisture values along with actual and digitally modeled optimal moisture target for a maximum flour yield, according to some embodiments.

FIG. 16 is an exemplary graph illustrating flour yields for recipe 9 at different moisture values along with actual and digitally modeled optimal moisture target for a maximum flour yield, according to some embodiments.

FIG. 17 illustrates the operation of the system 1, where (1) The AI or modelling engine 1043 has been trained on 2.5 years of data ~110,000 decisions; (2) The AI has learnt dependencies on influencing factors, including flour moisture; (3) It is now possible to not only mimic the miller's decisions, but also to give decision support to optimize the decisions; and (4) Steering parameters are signaled to the controller or alternatively recommendations are sent by email 3x per day and manually entered by miller. The milling system 1 provides a highly scalable approach since a plurality of flour milling machines 102 can be controlled and steered by the controller of the milling system 1.

FIG. 18 illustrates Proof of Concept (PoC) results of an automatically steered flour moisture control for yield optimization, with and without the machine-leaning based control signaling for the target moisture of the grains to be milled.

FIG. 19 illustrates benchmark data of an inventive milling system 1 captured during the year 2012. The setpoint in the benchmark involves a given set-off to the actual moisture which can be substituted for the benchmark.

FIG. 20 shows the exemplary measured results for the performance increase of an exemplary milling system 1 induced by the inventive machine-learning based automated control and steering system.

### DETAILED DESCRIPTION OF THE PREFERRED EMBODIMENTS

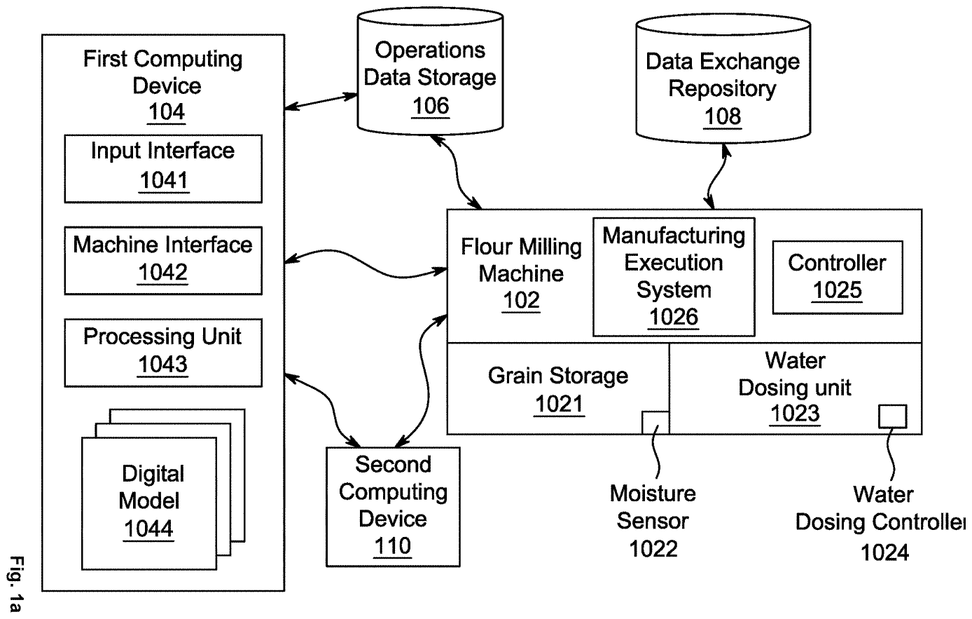

FIG. 1 to FIG. 20 schematically illustrate an architecture for a milling system 1 comprising at least one flour milling machine 102 providing optimized milling yield 16/1602 and providing an optimized milling process for granular or grainy raw material 1501 to be processed to flour 1502 by the milling machine 102. For example, the granular or grainy raw material 1501 can comprise grains and/or grain fruits of sweet grasses (poaceae) and/or legumes as chickpeas etc. Within this application, grains, inter alia, denote, fruits from cereal plants which are typically special cultivars of sweet grasses (botanically: Poaceae) with said grain fruits. Cereals belong to the class of angiosperms (flowering plants) within the seed plants including the deciduous trees, legumes, and nightshade family, in which the seed plant is enclosed in an ovary. One goal of a milling process is, inter alia, to optimize the achieved flour of the milling process in respect to the ash. In general, as used within this application, the term of flour or grain milling machine 102, also referred to as flour or grain mill, covers all technological processes for obtaining powdered (flour-like) or just dehusked or crushed products from coarse, solid vegetable matter, here on the one hand the preparation of grain into flour, semolina, haze and meal and on the other hand within the scope of hulling milling only the dehulling, the hulling, if necessary the subsequent crushing of the grain kernel. Thus, the technical goal of the milling process is to produce flour that is as bran-free as possible and bran that is as flour-free as possible by maximizing the achieved yield of flour. For example, with known prior art milling systems, the yield of type 550 flour is typically around 76-82% on average for wheat.

The milling system 1 comprises one or more flour milling machines 102, a first processing unit 104 and/or computing device, an operations data storage 106, a data exchange repository 108, and a second processing unit 110 and/or computing device. The one or more flour milling machine 102s, the first processing unit 104, the operations data storage 106, the data exchange repository 108, and the second processing unit 110 may be communicatively coupled directly or through a data transmission network or a suitable data transmission data link between the units.

The one or more flour milling machines 102 grind/mill the grains to flour. The flour milling machine 102 may include a controller 1025 for controlling the overall operation of the flour milling machine 102. The flour milling machine 102 is not explained in detail as the construction and operations are well known in the art. The flour milling machine 102 includes various sections including a grain storage 1021 section. The grain storage 1021 section is used for storing grains that would be used for milling. The grains are put into the grain storage 1021 post cleaning. The grains are cleaned to remove unwanted materials such as sticks, stones, straws, empty kernels, and such materials. Cleaning may be performed using various techniques such as using air currents, screens and such techniques to separate the grains from the chaff and other undesirable materials. Wheat is one of the important grain that is generally used for making flour. The rest of the disclosure is explained with reference to wheat, while the disclosure can be equally applied to other grains. Wheat has mainly three constituents known as germ, bran and endosperm. Post the cleaning, the cleaned wheat is ‘conditioned’. Conditioning refers to soaking the grains in moisture 202 for a defined period of time 204 to prepare the wheat for milling or grinding. The conditioning is performed to adjust the moisture 202 level of the wheat to separate the bran from the endosperm. In some examples, wheat is conditioned to 16% moisture 202 to enable the bran to flatten the bran into large flakes during the milling process. Referring back to the grain storage 1021, the grain storage 1021 includes a moisture sensor 1022 to measure a value of moisture 202 in the wheat. The moisture sensor 1022 communicates the value of moisture 202 in the wheat to the first processing unit 104. After the conditioning, the flour milling machine 102 grinds the wheat to flour as per the flour machine settings and consistency defined by an operator.

The current disclosure describes optimizing the milling performance to generate maximum achievable yield. Optimal milling performance hereby can be defined as one or a combination of following influence factors that provide a maximum achievable milling yield, while complying with quality specifications 1504. The influence factors include type of wheat (or grains) 1502, type of flour to be produced 1503 and quality specifications 1504, ambient conditions 1505 (that includes temperature, humidity, and pressure) at time of conditioning and milling, grain temperature 1506, process settings 1507 in the milling section (e.g., roller mill gaps, roller wear, sifter sieve configuration, and such configurations), moisture of raw wheat 1508, moisture of conditioned wheat 1509 (wheat mixed with moisture for a defined period of time 204) when entering the flour milling machine 102, and duration of conditioning of the wheat 1510, and varying time lag 1511 between dampening and milling. To achieve the optimal performance of the flour milling machines and maximum throughput, optimal amount of moisture 202 plays an important role.

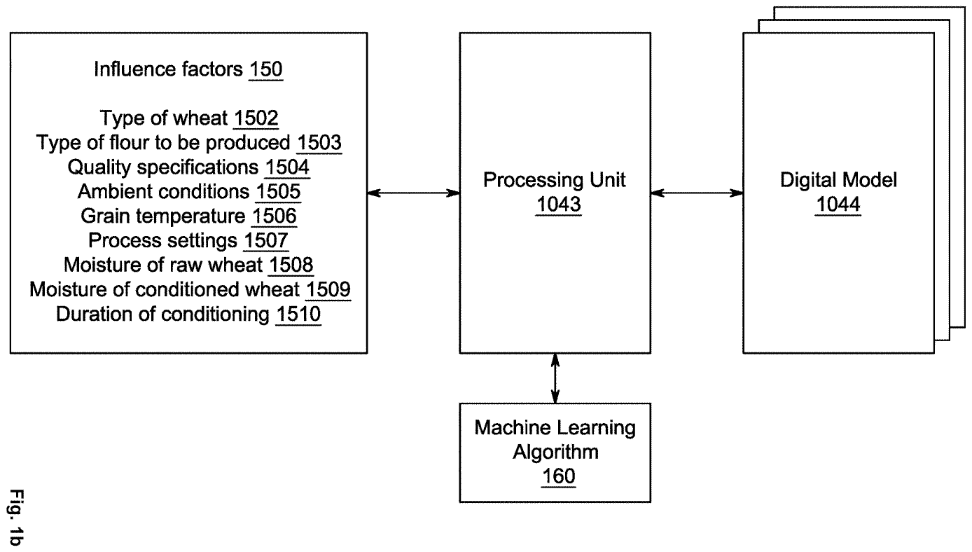

FIG. 2 shows an analysis of various factors that influence the production of the wheat flour in the flour milling machine 102 and their relative importance (relative importance obtained through predictive modelling for the flour output rate (kg/h)). The analysis shows that water (moisture) added for conditioning the wheat is the most important feature that impacts the flour. Another important factor that can be observed from the analysis is dampening (or conditioning) time 204. These factors, that is, the moisture 202 and dampening can be used in maximizing the amount of flour produced in the mill. Other features such as recipe type and ambient conditions 1505 also influence the milling yield and can be used to maximize the flour production. In order to achieve the optimal performance of the flour milling machine 102, using the influence factors, the disclosure implements the first processing unit 104. The first processing unit 104 is used for improving milling yield of the flour milling machine 102 to obtain optimized milling yield for a given raw material usage.

Referring back to FIG. 1, the first processing unit 104 may be a digital data processing unit or device, a server, a computer or a cloud device that can be accessed directly or over the network. The first processing unit 104 includes an input interface 1041 to receive input from a user or an operator. The first processing unit 104 includes a machine interface 1042. The machine interface 1042 receives historical flour milling machine operations data from the operations data storage 106. The historical flour milling machine operations data includes the data such as types of grains fed to the flour milling machine, temperature of the grains during milling, moisture in the raw grains, dampening time to condition the grains, moisture in conditioned grains, flour consistency specifications, ambient conditions 1505 at the flour milling machine 102, flour milling machine 102 settings, types of flours produced 1503 from the grains, and yield of the flour milling machine 102 for the grains at different temperatures, different moisture levels, different dampening periods, different ambient conditions 1505 and different flour milling machine 102 settings. The flour milling machine 102 settings include roller mill gaps, sifter sieve configuration, and roller wears. The historical flour milling machine operations may have been captured automatically and stored in the operations data storage 106 or may have been manually recorded and stored in the operations data storage 106. The machine interface 1042 also receives ambient conditions 1505 at the flour milling machine 102 from an input source. The input source may be a local weather report portal that provides information on temperature, humidity and atmospheric conditions of a local area that includes the flour milling machine 102.

The types of grains (for wheat), may include, inter alia, mainly Triticum vulgare (aestivum), Triticum durum and Triticum compactum. There are also wheats used from six different wheat classes that include hard red winter, hard red spring, soft red winter, durum, hard white wheat, and soft white wheat. The type of wheat used for the flouring may be based on the recipe of the flour. Temperature of the grains during milling may vary from season to season. In some examples, the grains are milled in the room temperature. In some examples, the grains are warmed or cooled with moisture before milling, referred to as conditioning temperature. A lot of flour milling operators condition the wheat to a range of 22-28° C. for better moisture absorption and ease of milling, and the temperature of the wheat is known to rise by 3-5° C. during tempering. Moisture in the raw grains are generally between 8% to 25%. Many times the flour milling organizations procure wheat having 15-20% moisture as the wheat in aforementioned range preserves the quality of grain for longer durations. In some examples, the flour milling organizations dry the procured wheat to arrive at a range of 13-18% moisture for best results.

The dampening time 204 (interchangeably referred to as conditioning time) to condition the wheat refers to the time that is provided to enable water to penetrate the kernels of the wheat. In some examples, some flour milling organizations use mixers such as low-speed mixers and dampeners for dampening process. The dampening time 204 may depend on the flouring requirements and moisture in the wheat. If the wheat has high moisture, the conditioning time may be less required. If the wheat has low moisture and the wheat is hard, more conditioning time may be required, sometimes up to 72 hours to increase the moisture content in the wheat. The moisture in conditioned grains is one of the important factor that determines the quality of flour. Typically, for wheat that is hard, the moisture content around milling is generally maintained is about 16.0-17.0%, for semi-hard wheat, the moisture content that is generally maintained is about 15.5-16.0%, for wheat of semi-soft nature, the moisture content that is maintained is about 15.0-15.5%, and for soft wheat, the moisture content that is maintained is about 14.5-15.0%. The flour consistency specifications are requirements of flouring. The consistency specifications include fine milled, coarsely milled, and semi-finely milled flours. The ambient conditions 1505 at the flour milling machine 102 include temperature, atmospheric pressure, and humidity at the time of milling. The temperature is known to rise at the flour milling machine 102 by a few degrees during milling due to friction while milling. The flour milling machine 102 settings include roller mill gaps, roller wear, sifter sieve configuration and the like that is used for making flour of different consistencies. The types of flours produced from the grains may be based on the recipe of the flour. Examples of flour include, but are not limited to, all-purpose flour, bread flour, cake flour, and pastry flour. There may be records associated with the operations of the flour milling machine 102 that are maintained to tracks the yield of the flour milling machine 102 for the grains at different temperatures, different moisture levels, different dampening periods, different ambient conditions 1505 and different flour milling machine 102 settings. The yield may be different for different wheat and for different moisture levels.

The first processing unit 104 includes a modelling engine 1043 to process historical flour milling machine operations. In one or more embodiments, the modelling engine 1043 may collect relevant data and instances that can be used for training and testing a machine learning model structure. In some examples, the modelling engine 1043 uses may use predictive modeling to capture the non-linear dependencies of the influencing factors and particularly to determine water (moisture) to be added for conditioning the wheat to maximize flour extraction. The predictive modeling may refer to a statistical technique that is capable of predicting related, future events or related behavior. The predictive digital modeling involves forecasting or predicting related or future outcomes or events by analyzing different patterns based on past events. In the disclosure, the predictive modeling includes analyzing the historical flour milling machine operations to capture the non-linear dependencies of the influencing factors. In some examples, the modelling engine 1043 may use a process of predictive analysis that includes, inter alia, descriptive analysis of the historical flour milling machine operations, data preparation, data modeling and performance estimation.

The step of descriptive analysis of the historical flour milling machine operations data includes analysis of data to understand various relationships and dependencies. For example, descriptive analysis may include analysis of influence factors and impact on the flour production. In one example, the descriptive analysis may involve recognizing the flour milling machine 102 yield or the quantity of wheat flour generated in an exemplary flour milling operation using a x type of wheat at a given temperature, with a requirement of flour to be coarse when the ambient condition in the flour milling machine 102 was hot, humid and having normal pressure at a time of milling, type of setting in the flour milling machine 102, y amount of moisture in the raw wheat, z amount of moisture in the conditioned wheat, and a duration of conditioned wheat. The descriptive analysis step of the historical flour milling machine operations data involves analyzing and identifying various relationships and dependencies from such several instances and their impact on flour production. In some examples, the instances may be in order of several thousands or millions or more or less.

The step of data preparation may include preparing the historical flour milling machine operations data. In some examples, there may be many instances in the historical flour milling machine operations where some information in data may be missing. For example, using the above example where recognizing a quantity of wheat flour generated in the flour milling operation, information related to a moisture content in the raw wheat may be missing. In such instances, dummy flags or a value derived from mean of several other data may be used to update the missing value. In some examples, there may be instances where the values may be outliers. For example, a moisture content in the conditioned wheat may be abnormal to be termed as outlier in one of the historical milling operations. In such instances, the outlier value may be removed or normalized based on the other values. In some examples, there may be incorrect or irrelevant data. For example, the flour mill output may be significantly higher than expected than general output for a given wheat input. In such instances, such instances may be discarded or normalized based on the other data.

The step of data modeling involves using modeling the prepared data by choosing appropriate machine learning techniques. Since predictive modelling uses known results to generate, process, and validate a model structure that is used to forecast future events and outcomes, known predictive modeling techniques may be used. Some examples of predictive modeling techniques include but are not limited to decision trees, regression, Bayesian analysis and neural networks. In some examples, neural networks and regression may be used in data modeling for the historical flour milling machine operations data. The modelling engine 1043 generates a digital model structure of the flour milling machine 102 based on the predictive modeling. In one example, the digital model structure may be a machine learning module generated using machine learning techniques. In some examples, the digital model structure may be an artificial intelligence (AI) model structure generated by combining the historical flour milling machine operations data with intelligent, iterative processing algorithms to learn from patterns and features in the data that they analyze. The digital model structure may be an output of a training process and can be a representation of the real-world flour milling machine 102. Based on the historical flour milling machine operations, the digital model structure may implement the non-linear dependencies of the influencing factors that affects milling performance and flour yielding of the flour milling machine 102. Particularly, the factor of water (moisture) to be added for conditioning the wheat to maximize flour extraction for a given amount of wheat may be determined. Using the generated digital model structure, performance estimation may be performed, e.g. by measuring parameter values processing.

Consider an example of neural networks for digital modeling using the historical flour milling machine operations data. Neural networks may refer to method modelled on a human mind that teaches a processing unit to process data in a way the human does. The neural networks may be employed for identifying non-linear relationships preferably emulating the way that a human identifies in accordance with the disclosure. The neural networks include multiple layers of receptive fields that are small neuron collections configured to process portions of the data. The output of each layer is successively tiled such that the input overlaps to obtain a representation of the data. In examples, framework such as Caffe that uses MATLAB and Python programming languages may be used in implementing the neural networks along with appropriate python analytics libraries.

A pre-defined dataset from the historical flour milling machine operations data comprising, for example, 40000 rounds of operations are used as a training dataset for training the digital model structure, although more data operations can be used. The training dataset comprises labels associated with each round of operation. The labelled data are pre-processed and stored in a Python script format. The training dataset may be then divided into 2 subsets. First subset called the training set comprises ⅘^{th} portion of the training dataset that are used for training the data model structure. In some examples, the first subset may include of about 85-90% of the training dataset for training the data model structure. The second subset called a test set comprises ⅕^{th} portion of the training dataset data of operation are used for calculating and validating accuracy of the model structure as shown in 304. In some examples, the test set can have 50-15% of the training dataset of the operation.

The digital model structure performs classification using the training set. The classification is a training process that may involve supervised or unsupervised machine learning, in which the digital model structure learns from the training set provided therefor. The digital model structure uses this learning to classify new observations. In the current disclosure, the digital model structure learns from various operations in which different influencing factors lead to different flour output. In the process of learning, the digital model structure captures the non-linear dependencies of the influencing factors that affects milling performance of the flour milling machine 102 and particularly, the effect of the influencing factor of water (moisture) on flour extraction for different amounts of wheat. The training dataset includes instances where the flour outcomes were obtained for different combinations of influencing factors. For example, one instance showed that hard spring wheat with a moisture content of 16% led to a flour yield of 92% for a wholemeal flour. In another example, another instance showed that hard spring wheat with a moisture content of 17% led to a flour yield of 95% for a wholemeal flour. Similarly, one instance showed that a hard red winter wheat with a moisture content of 15.5% led to a flour yield of 84% for a brownish flour. In another example, one instance showed that hard red winter wheat with a moisture content of 16% led to a flour yield of 85% for a brownish flour. Using such instances and many such other instances, the digital model structure learns variations in different influence factors 150 and particularly, the variation in moisture content leading to different flour yields.

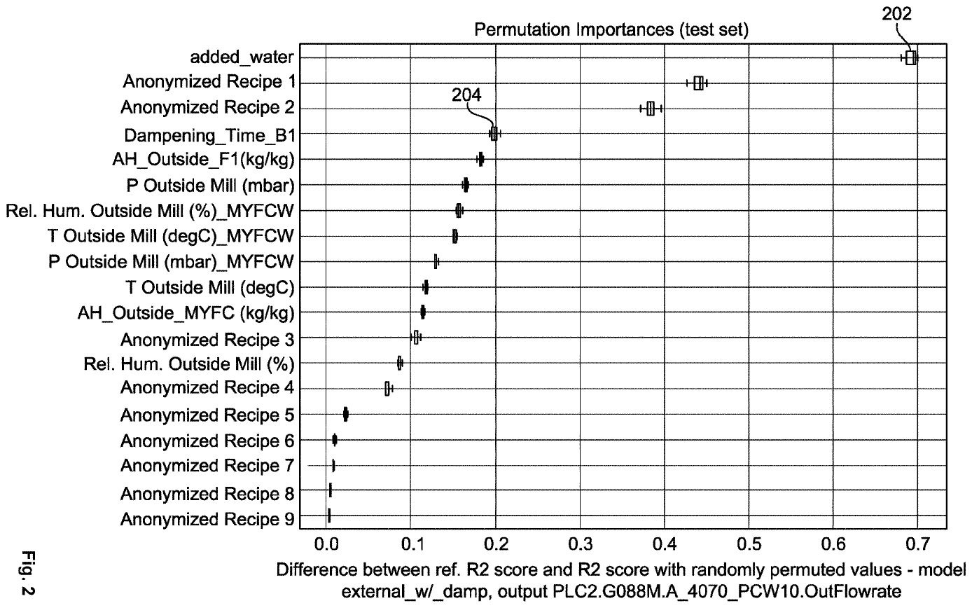

Using the ‘learned’ digital model structure, performance estimation may be performed. In one or more embodiments, the test set of the training dataset may be used for testing the digital model structure. Conventionally, the larger the training set, better the results on the test data. However, if the training set is lesser than 75% to 80%, the results may not show a high level of accuracy. For example, as shown in FIG. 3 (as shown by 304), the training set is about 70% and the test set is about 30% of the training dataset which did not provide great performance of the digital model structure. In one or more embodiments, the training set and the test set with a temporal overlap may work best for training and testing, which leads to a good performance of predictive model structure on the test set (shown by 302). Other predictive modeling techniques not described herein are contemplated herein. In some embodiments, the digital model structure may be able to perform simulate an operation of the flour milling machine 102. In one or more embodiments, for statistical sampling reasons, it can also be beneficial to superpose a noise signal on the recommended moisture setpoint (value) to ensure sufficient sampling of the influence factor space, to capture any potential drifts of the optimal moisture setpoint (values). This will make sure that the required statistical variability of the setpoints is available for a meaningful continued analysis and optimization of the mill over the entire lifetime of a mill.

The flour milling machine 102 operators can make one or more policies and test the one or more policies on the digital model structure to determine performance of each of the policies. The policies may refer to providing various influencing factors to the digital model structure to determine the flour milling machine 102 output virtually. For example, the operator can input a first wheat type at a given temperature, with a requirement of flour to be fine, providing the ambient condition in the flour milling machine 102, settings in the flour milling machine 102, amount of moisture in the raw wheat, amount of moisture in the conditioned wheat, a duration of conditioned wheat, ant type of flour, etc., to determine the flour yield. The operator can make n-number of policies and test the policies to determine one or more optimal policies that yield best results. In other words, the disclosure uses the digital model structure as a retrospective simulation of the performance of the flour milling machine 102, as enabler of an offline optimization of moisture addition policy. The digital model structure enables testing of different policies on this retrospective simulation and quantifying and benchmarking improvement potential (in terms of flour output increase). One example of such policies are data-driven optimization strategies that are easier to implement and maintain in practice compared to data-hungry machine learning algorithms. Some examples of such optimization strategies are explained in the following paragraphs.

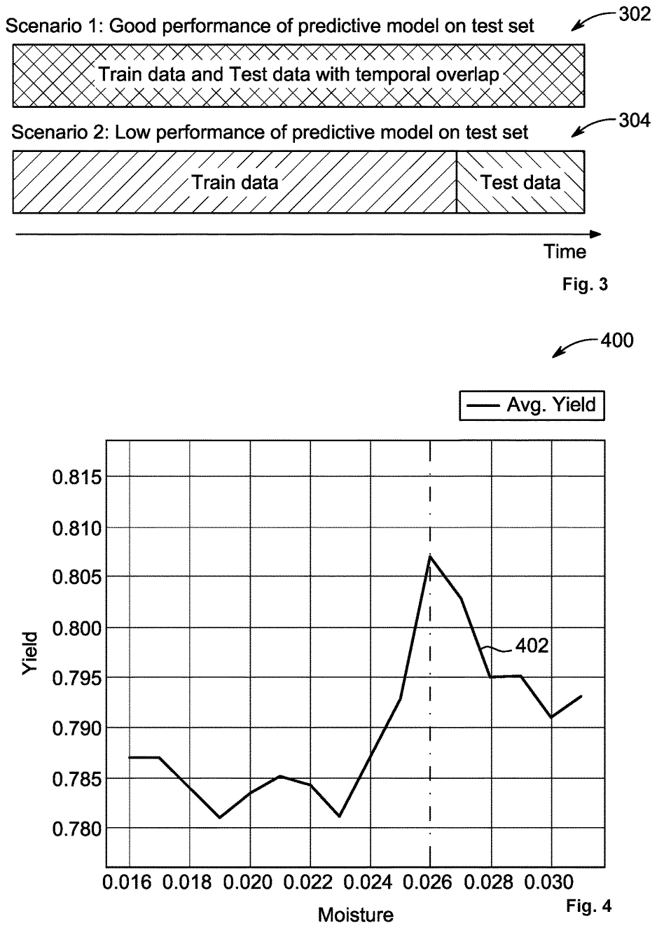

The operators can evolve their strategies for a need based on requirements. For example, the operator can make a global approach policy where different recipes are input as part of influence factors 150 and moisture addition values that yield the maximum flour yield, based on the training data may be generated. FIG. 4 illustrates an example where a result of execution of the global approach policy by the digital model structure is shown as a plot 400. The y-axis indicates a yield for a given wheat for a given recipe, the x-axis indicates moisture values that can be added and average yield curve 402 indicates the variation in flour yield for different moisture levels. The digital model structure executes the policy to indicate that the maximum yield for the given wheat can be obtained when 0.026 g/m³ moisture is added to the wheat.

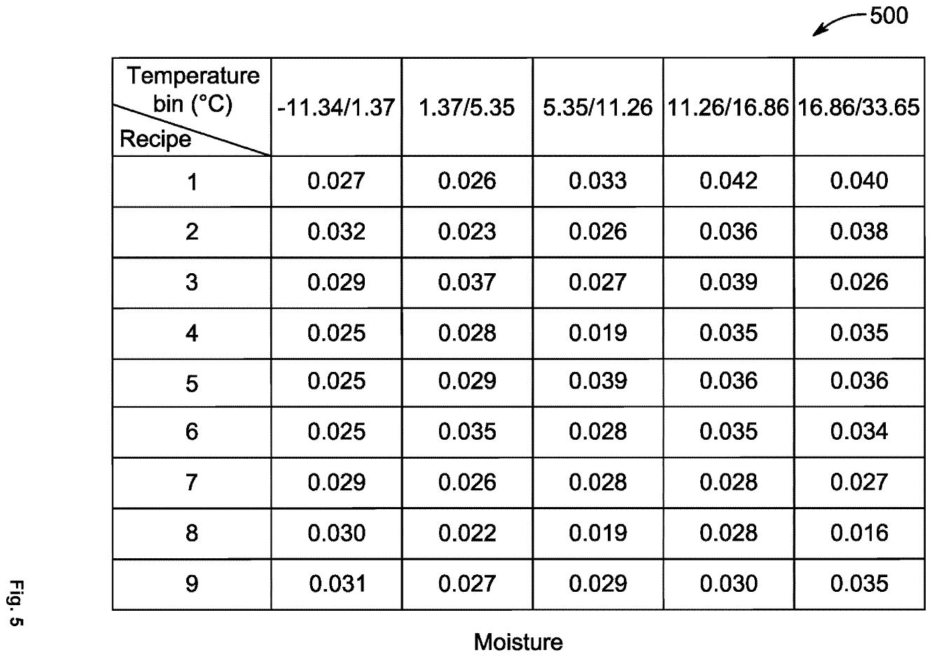

In another example, the operator can make a seasonal based approach policy where different recipes and ambient conditions 1505 as per seasons are input as part of influence factors 150, and moisture addition values that yield the maximum flour yield, based on the training data may be generated, that is a moisture addition value for summer season, a moisture addition value for a winter season, a moisture addition value for an autumn season, a moisture addition value for a monsoon season and the like. In another example, the operator can improvise this seasonal based approach policy to a floating seasonal approach where different recipes, and different ambient conditions 1505 as per seasons are input as part of influence factors 150 and interpolated, and moisture addition values that yield the maximum flour yield, based on the training data may be generated, that is a moisture addition value for core seasons, transitioning seasons and different ambient conditions 1505 for a given day. In another example, the operator can make policies that can be based on multiple influence factors 150. For example, the operator can make a temperature-controlled approach policy, where for the different recipes, at different temperatures may be input and moisture addition values that yield the maximum flour yield based on the training data may be generated, that is, a moisture addition value for different temperature bins. FIG. 5 illustrates an example where a result of execution of the temperature-controlled approach policy by the digital model structure is shown in a form of a table 500. The recipes are numbered and shown on left hand side of the table 500, temperature ranges of the grain storage 1021 is shown in first row of the table 500 and rest of the table 500 shows various moisture values for 9 different milling recipes, split by outside temperature at time of conditioning that yields the maximum flour yield.

An example of performance of the above policies executed by the are shown in table 1 below.

The table 1 below shows results of increase in the flour yield in virtual test in the digital model structure with nine milling recipes, based on two years of data collected.

| | Modelled performance increase |
|---|---|
| Approach | (% increase of flour output) |
| Seasonal | 0.7 |
| Daily floating seasonal | 0.5 |
| Temperature-controlled | 1.6 |

The one or more rule-based, threshold-based or otherwise triggered parameter values or signaling may be deployed in the flour milling machine 102 directly through a controller 1025. In an example, the first processing unit 104 may communicate the one or more parameter values through the machine interface 1042. The controller 1025 may communicate with the water dosing controller 1024 of the water dosing unit 1023 to provide moisture values to control/provide required moisture content as per the one or more policies. Accordingly the water dosing controller 1024 controls the amount of moisture provided to the grain storage 1021. The moisture sensor 1022 in the grain storage 1021 may continuously monitor the moisture in the wheat and may provide feedback to water dosing controller 1024 and/or the controller 1025 about the moisture levels in the wheat. As a result, the moisture addition/control is automated in the flour milling machine 102. It is to be noted, that, inter alia, the tempering process in the milling system 1 can be a key process in the wheat flour milling that requires proper adjustments to achieve a desired level of flour quality and yield. This is because the moisture content of the grain depends on the tempering, and thus it can be an important feature to automatically predict the moisture content of the grain, e.g. the wheat, at the end of the stage of tempering.

To adjust moisture content of the initial grainy material to be processed to the desired target moisture, the forecast of a moisture content after the tempering process by the milling system 1 can e.g. realized by a machine-learning based digital modeling structure, based on measured grain or wheat properties (e.g. comprising initial wheat moisture content, wheat protein content and wheat temperature), process parameters (targeted wheat moisture content, wheat flow rate, water flow rate, wheat quantity and resting time) and tempering conditions (water quantity and day weather). The increase of wheat moisture achieved during one tempering stage typically varies between 0% and 5%. For the present invention, a ElasticNet model structure can be preferrable since it typically outperforms others in determining the final increase of wheat moisture with an average prediction errors of 0.21%. In the inventive flour production process, milling is at the heart of the milling system 1. The goal of the process is to break the grains into particles and reduce those particles into flour. Conditioning the wheat grains plays a major role in the efficiency of the process, as already discussed above. The entire process is mainly linear, composed of several ordered steps comprise: cleaning, conditioning, and milling. First, the cleaning process has as its objective to get rid of all impurities or foreign materials that could damage machines or impact flour quality. Second, the conditioning or tempering of wheat grains seeks to increase the moisture content of the wheat grains. By increasing the moisture content to a certain percentage, the milling operations run more smoothly and efficiently. Lastly, milling occurs by the flour milling machine 102 which can e.g. be divided into two operations: breaking the grains into particles and reducing the particle size. Those two operations can be conducted successively in a multi-stage environment. The

The modelling engine 1043 can e.g. generate one or more steering parameters automatically based on a specific set of flour milling operation data 150. The steering parameters, e.g. the target moisture of the grain material 150111 can e.g. also preliminary be communicated to an operator who, in return, can choose an optimal policy and may deploy the policy through the first processing unit 104. However, preferably, the modelling engine 1043 steers and operates the controller 1025 directly, the controller 1025 communicating an optimal policies to the flour milling machine 102 through the machine interface 1042. The controller 1025 may communicate with the water dosing controller 1024 of the water dosing unit 1023 to provide moisture values to control/provide to the grain storage 1021. Thus, the water dosing controller 1024 of the water dosing unit 1023 controls and steers the tempering process whereby water is added to grains, e.g. wheat grains, followed by a period of resting in an empty silo to let the water penetrate in the wheat. The impact of the tempering process on flour quality and flour yield can be measured and captured as historic parameter values. Depending on the wheat moisture content attained, flour yield and flour quality are impacted during the milling process. As the wheat moisture content increases, typically yield output decreases and flour quality increases. The milling system need to achieve an optimized trade-off, in particular for the manufacture of white flour, which should not be contaminated by the bran.

In this context, it is also to be noted that the wheat moisture is also an indicator for good storage. Wheat can be stored longer if its moisture content is kept below approximately 14%. However, before milling, to optimize the yield, the moisture has to be raised, e.g. to about 16%. This increase of moisture has the effect of hardening the bran while making the endosperm more friable. In producing white flour, the goal is to extract as much endosperm as possible from the grain without any bran contamination. Tempering thus helps during milling to separate the endosperm from the bran, which by consequence improves the final flour quality and yield. Moreover, tempering helps compensate the loss of moisture that occurs during milling operations. However, adjusting the tempering process manually is difficult as it is affected by several factors. Those factors include: wheat properties, moisture, temperature, time, and the tempering bin space available. Furthermore, the wheat mixes realized before the tempering stage add complexity to the good control of the process. The present invention has the advantage that this process can be fully automated achieving an optimized yield of flour. Further, in traditional tempering stages, the miller, by his experience and knowledge, has to adjust tempering parameters (in particular moisture content) depending on the wheat quality, wheat mixes and environmental conditions. Depending on the type and quality of flour desired, a target moisture content is established, representing the moisture content to be reached at the end of the tempering stage. This target moisture content with the flow of the wheat grains and the initial moisture content of the wheat determines the flow of water used during the tempering process. Other parameters to be controlled are the flow of wheat grains, wheat quantity, the duration of the resting time and the number of tempering stages.

The proposed machine-learning-based modelling engine 1043 can e.g. be based on a regression modeling structure 10432. To build and train the digital modeling structure 10432, the following different steps can e.g. be performed: First, the training data are collected. Second, the data is formatted, cleaned, and transformed to make it ready for a regression modeling structure 10432. Third, the modeling structure 10432 is trained. Lastly, validation measures the performance of the modeling structure 10432 on new data. A machine-based comparison of the performance of the different modeling structures 10432 can also be applied. In the prior art, no predictive machine-learning based modelling and signaling engine 1043 exist.

For the data collection, i.e. the capturing of the historical flour milling operation data 1061 points have to be identified along the processing chain and the data collected at those checkpoints. It is important that the data capture reflect the process workflow and the milling system 1. Most data are available from the sensor equipment of the mill system 1 which can e.g. be stored in an SQL Server database linked to the Supervisory Control and Data Acquisition (SCADA). The data can e.g. be recorded periodically, e.g. every 10 minutes. The data can e.g. include the quantity of wheat transferred from one stage to another and the quantity of water used. From that data it is possible to generate the resting time in each stage of the tempering process. The wheat quality and control parameters of the tempering stage are e.g. be stored. For each production run, a data file can e.g. be created that contains the capture flour milling operation data 1250, in particular data about the quantity of wheat used, the different tempering stage conditions and parameters adjusted as well as the milling conditions.

Further, the captured flour milling operation data 1250, i.e. the sensory and operational data collected are typically not ready to be used. For this reason, it is formatted, cleaned, and transformed. Inconsistent data can be found during the formatting of the data. Based on statistical filter analysis or machine learning algorithms outliers present in the dataset can e.g. be detected. With the help of clustering techniques, it is possible to spot outliers and check the real causes of the existence of the outliers. By verifying their information inputs, corrections can be made. This implies deleting the example if the data doesn't make sense, correcting it if possible or keeping it as it is if there are no incoherencies in the example. Also, different approaches can be used to deal with missing values, for example, removing the examples, using learning algorithms that handle missing values and using data imputation techniques. Data imputation consists of filling in partially missing data with substituted values. Then, the cleaned data must be transformed to the right format to process it in a machine learning modeling structure efficiently. If independent variables have vastly different scale sizes and the machine learning algorithm is sensible to those different scales, it is recommended to apply feature scaling on the data Finally, all the data can e.g. be merged in one table, where e.g. each row represents an example of the milling process run. Each column represents a feature variable. The last column holds the output variable that has to be predicted, i.e. the target moisture. To train and evaluate afterwards the learning structure, the prepared data can e.g. be split to two datasets where, for example, 85% of the dataset is used for training the model and 15% is used for testing the mode.

After the data has been prepared, the digital model structure 10432 can be selected and trained to predict the output variable, i.e. the target moisture content of the input grains 150111 to the flour milling machine 102. For example, a regression modeling s structure showed to be well suited for the purpose. Deep learning models such as neural networks may have disadvantages to be considered for the regression modeling structure due to the small size of the dataset available. In the present case, different regression modeling structures can e.g. be applied, such as linear regression, polynomial regression, stepwise regression, ridge regression and ElasticNet regression. To achieve the most optimized modelling structure 10432 depending on the data at hand and the hyperparameters to adjust. For these reasons, several modeling structures 10432 can e.g. be built, optimized, and compared.

For the inventive modelling structure 10432, due to the possible presence of multiple independent variables, it is essential to check for multicollinearity. Multicollinearity happens when independent variables are highly correlated to each other. In the present case, it can cause the modeling structure 10432 to overfit and impact the forecast performance of the optimal target moisture. To detect multicollinearity, several options are possible. First, a correlation matrix can e.g. be used to provide a good indication on the possible existence of multicollinearity between pairs of independent variables. Second, the Variance Inflation Factor (VIF) test can be conducted. In general, multicolinearity exists and becomes problematic when a VIF value greater than 10 is obtained. In the case of multicollinearity, it is possible to delete or transform the dependent variables. Another way to treat this issue is by using regression algorithms such as LASSO, RIDGE and ElasticNet that can reduce the risk of multicollinearity. By adjusting their different parameters, it is possible to penalize some independent variables and reduce or eliminate their influence on the model. The main difference between LASSO, RIDGE and ElasticNet, in the present case, is the penalty terms they use for the different weights present in the model. Further, to evaluate and tune the hyper-parameters of regression modeling structure 10432, k-fold cross-validation can e.g. be used. The k-fold cross-validation splits the dataset into k-folds. In an iterative process, each of the k-folds will be used to test the modeling structure 10432 and the rest will be used to train the model. The average of the prediction accuracy on each k-fold represents the model performance. By testing different values of hyper-parameters and evaluating the model performance, the best hyper-parameters can e.g. be found that generalize the digital modeling structure 10432.

To evaluate the pertinence and performance of the digital modeling structure 10432, for example, a validation step can be conducted. The validation of the digital modeling structure 10432 can e.g. be conducted on the test set, as discussed above. The metrics used to evaluate the performance of the model can e.g. be based on the R-square and Mean Square Error (MSE). The R-square allows to generate the degree of variation explained by the modeling structure 10432. It is a metric that fluctuates between 0 and 1. A value close to 1 indicates that the model structure 10432 explains most of the variation of the data, thus making the model accurate for future prediction. Finally, MSE measures the average error of the predicted values from the model compared to the real values. A small MSE indicates low distant average errors between the regression modeling structure 10432.

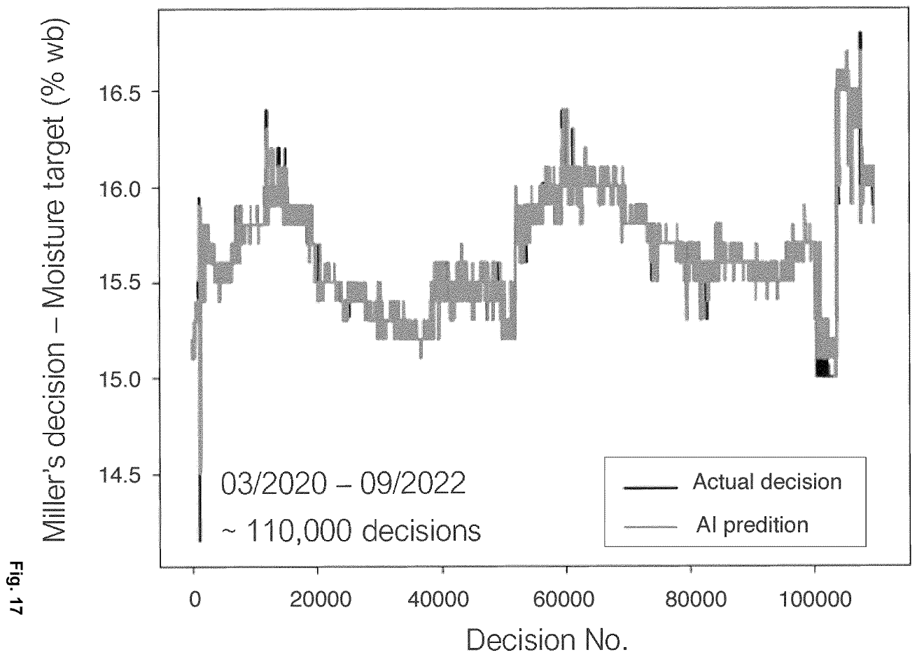

FIG. 17 illustrates the operation of the system 1, where (1) The AI or modelling engine 1043 has been trained on 2.5 years of data ~110,000 decisions; (2) The AI has learnt dependencies on influencing factors, including flour moisture; (3) It is now possible to not only mimic the miller's decisions, but also to give decision support to optimize the decisions; and (4) Steering parameters are signaled to the controller or alternatively recommendations are sent by email 3x per day and manually entered by miller. The milling system 1 provides a highly scalable approach since a plurality of flour milling machines 102 can be controlled and steered by the controller of the milling system 1.

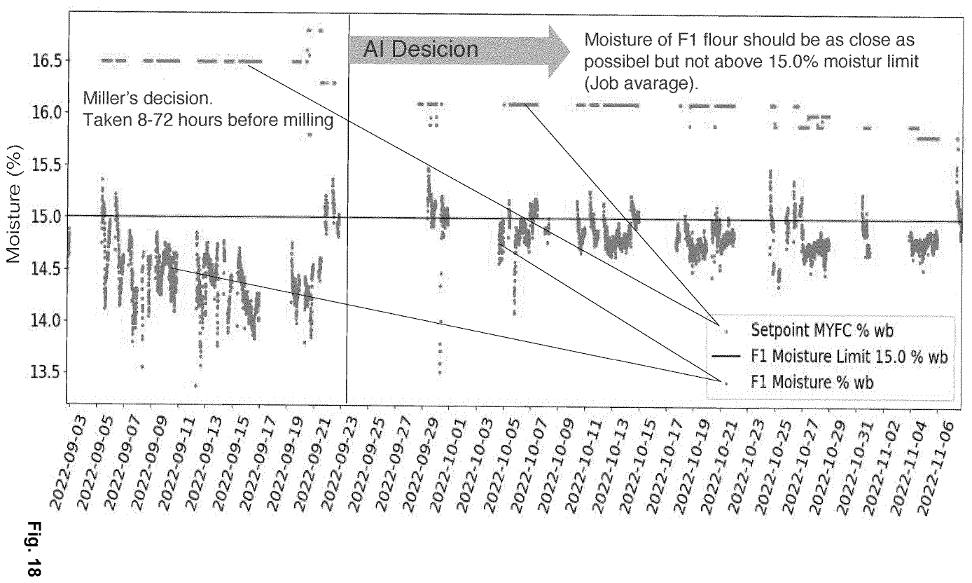

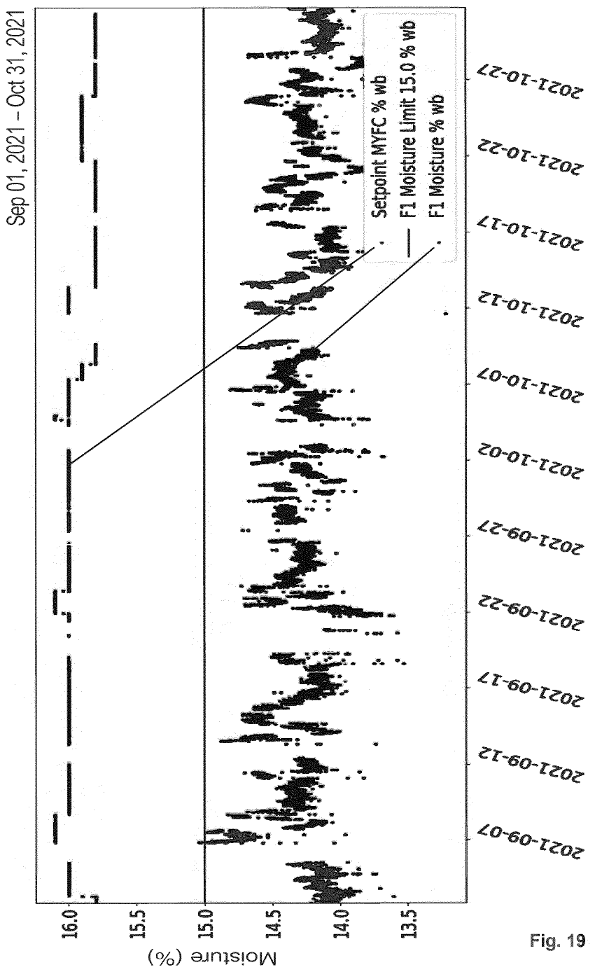

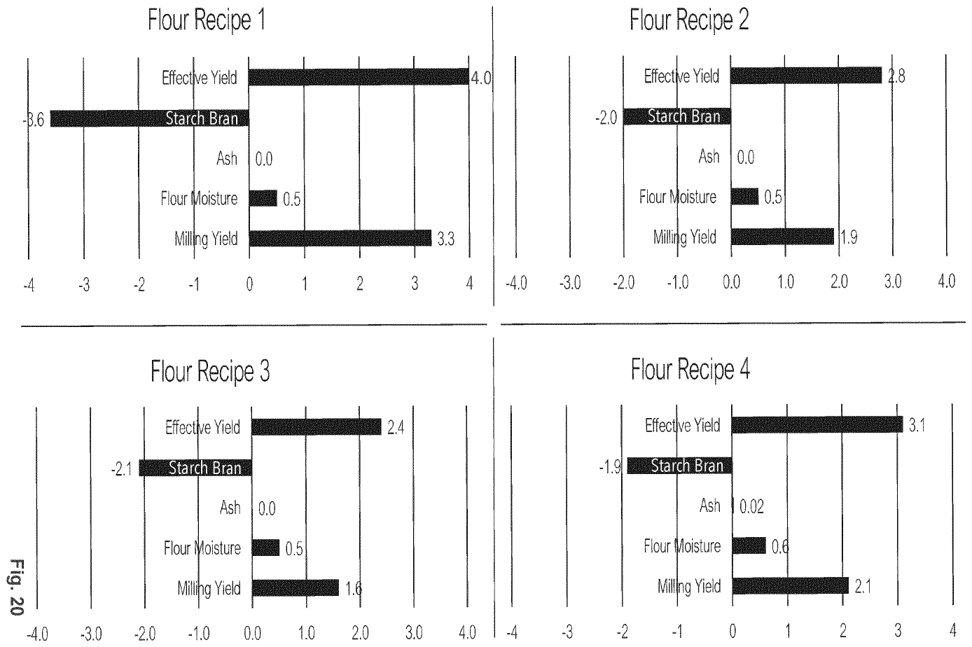

FIG. 18 illustrates Proof of Concept (PoC) results of an automatically steered flour moisture control for yield optimization, with and without the machine-leaning based control signaling for the target moisture of the grains to be milled. Further, FIG. 19 illustrates benchmark data of an inventive milling system 1 captured during the year 2012. The setpoint in the benchmark involves a given set-off to the actual moisture which can be substituted for the benchmark. Finally, FIG. 20 shows the measured results for the performance increase of the milling system 1 induced by the inventive machine-learning based automated control and steering system.

In one or more embodiments, the operator can fine-tune and deploy one or more parameter settings (policies) through the first processing unit 104. In one example, the operator may make one or more policies that require minimal operator intervention. For example, the operator can have a policy requiring minor updates in a given day, such as once a day, at beginning of a job where the operator can set the moisture setpoint in the flour milling machine 102 based on output moisture target of the policy. This can be implemented by obtaining recommendations for assisted manual user input from the policies. The flour milling machine 102 may include manufacturing execution system 1026 through which the operator can provide input. The manufacturing execution system 1026 may include interface such as monitor, keyboard, mouse and other interfaces for the operate to manually input and view condition of the flour milling machine 102. In another example, the operator may make one or more policies that may need more updates or frequent updates (such as hourly or due to frequent changes in influence factors 150) in a given day. In such situations, an automated solution may be implemented, where the one or more policies may be deployed in an edge computer which is the second processing unit 110 or a cloud computing device, and based on the updates, the new moisture setpoints may be generated and deployed automatically in the flour milling machine 102.

In some implementations, the digital model structure may be executed in the second processing unit 110 and the one or more policies may be tested or generated in the second processing unit 110. Further, the moisture values generated from the digital model structure may be implemented in the flour milling machine 102 in a similar manner as described above for the first processing unit 104.

In some implementations, the modelling engine 1043 may be used to directly control the addition of moisture content in the flour milling machine 102. In an example, the modelling engine 1043 may communicate with the controller 1025/the water dosing controller 1024 to provide target moisture values to control/provide moisture to the wheat in the grain storage 1021. However, to prevent distributional shift of data characterizing the flour milling machine 102 due to sensor drifts, raw material variability, part wear, new recipes, data inconsistencies, etc., this implementation may be less preferred.

Post addition of moisture or dampening period, the flour milling machine 102 is triggered to operate to flour milling machine 102 to mill the wheat to flour, and the amount of the flour or flour output is measured.

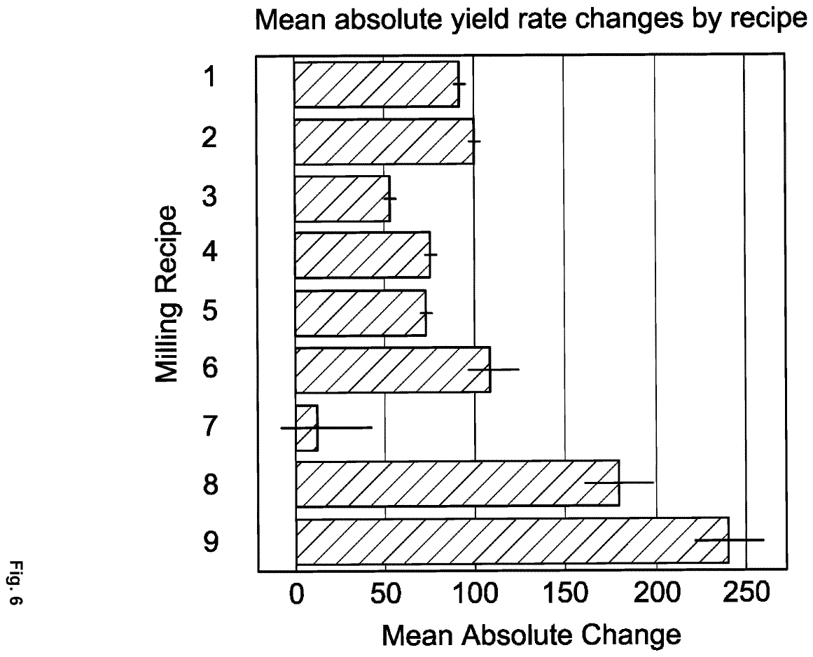

FIG. 6 illustrates a result of test instances indicating performance increase for 9 recipes for the exemplary temperature controlled policy described above. The y-axis indicates a milling recipe while the x-axis indicates a mean absolute change in yield. The bars in the figure indicate the yield by bins, while the lines at the edge of the bars indicate a performance increase.

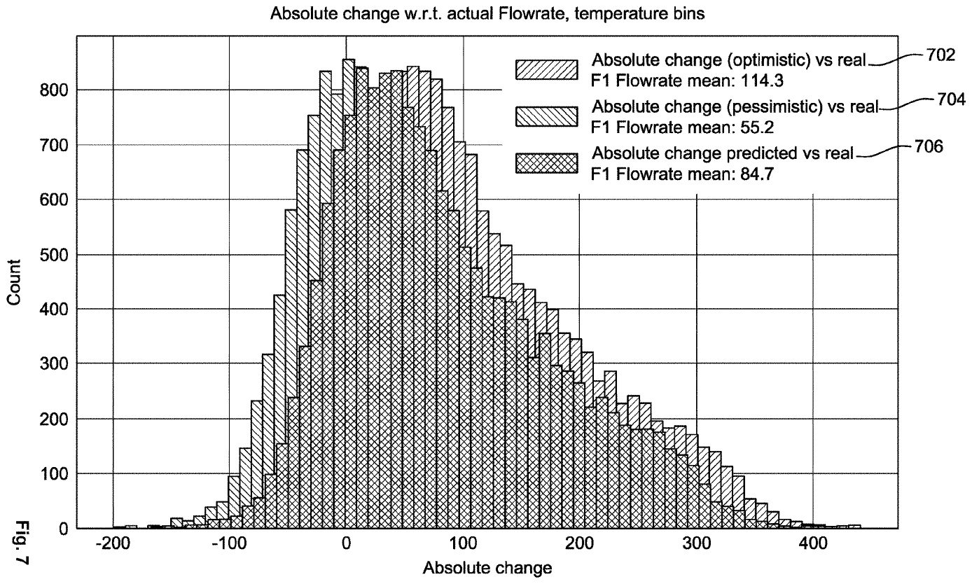

FIG. 7 illustrates a histogram of a modelled performance increase, optimistic, pessimistic, and mean scenario (taking into digital model uncertainty), based on two years of data from an industrial flour milling machines. The y-axis indicates a count, while the x-axis indicates a mean absolute change in yield. The right hashed bars in the figure indicate an optimistic absolute change vs. real flow rate with a mean of 114.3. The left hashed bars in the figure indicate a pessimistic absolute change vs. real flow rate with a mean of 55.2. The cross hashed bars in the figure indicate a predicted absolute change vs. real flow rate with a mean of 84.7.

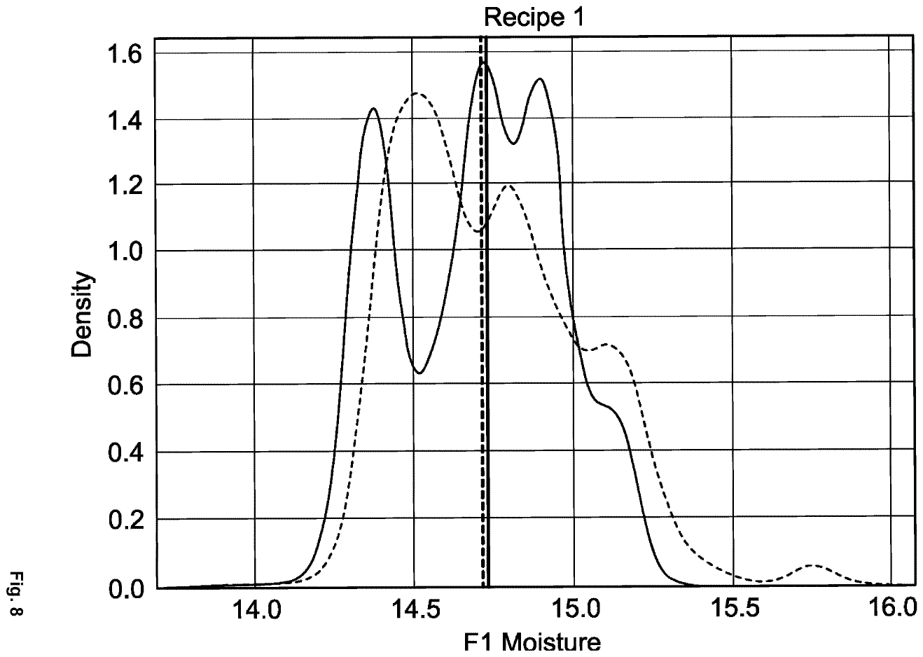

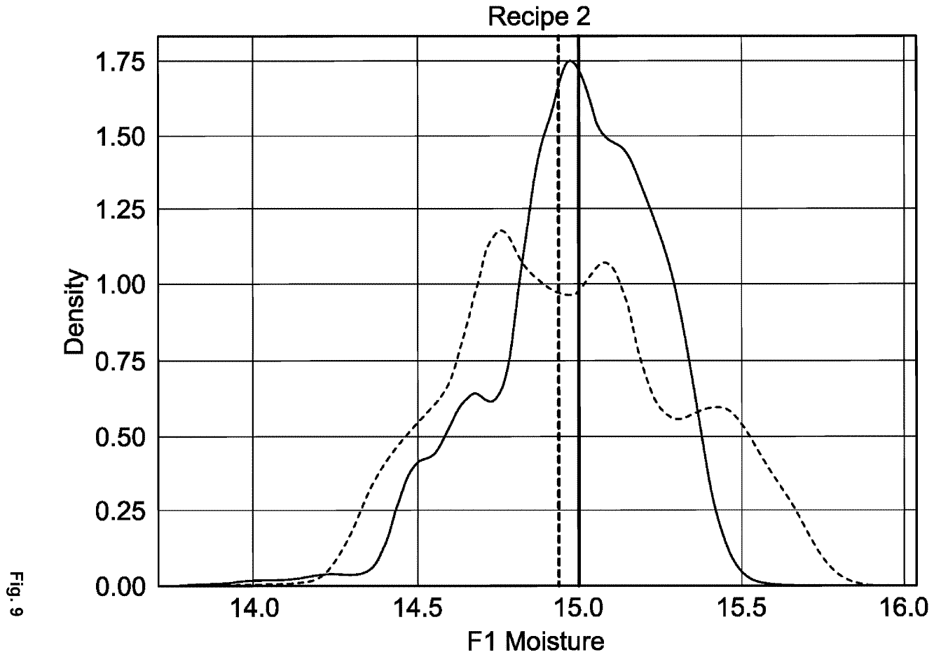

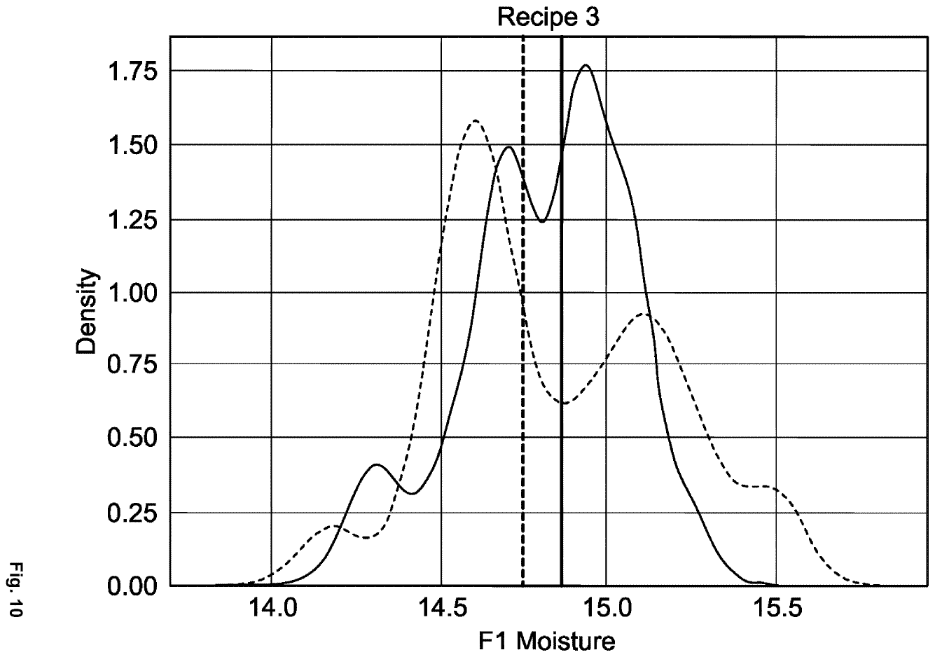

In one or more embodiments, as per the quality requirements, the moisture of the flour below is required to be maintained typically at 15%. Charts shown in FIG. 8-FIG. 16 show worst case estimations of finished flour moisture after application of the optimization strategy for various milling recipes where line curves indicate actual moisture, and dotted lines indicate modelled moisture. It can be seen from the execution of the digital model structure that the modelled moisture is comparable to the actual moisture observed in flour production. FIG. 8 shows a line curve that indicates actual moisture and a dotted line that indicates modelled moisture with the optimal moisture for maximum flour yield seen at 14.7 for recipe 1 for maximum flour yield. FIG. 9 shows a graph for recipe 2 with line curve that indicates actual moisture and dotted line that indicate modelled moisture with the optimal moisture for maximum flour yield seen at around 15.0 for maximum flour yield. FIG. 10 shows a graph for recipe 3 with line curve that indicates actual moisture, and dotted line curve that indicates modelled moisture with the optimal moisture for actual moisture seen at 14.8 and modeled moisture seen at around 14.75 for maximum flour yield.

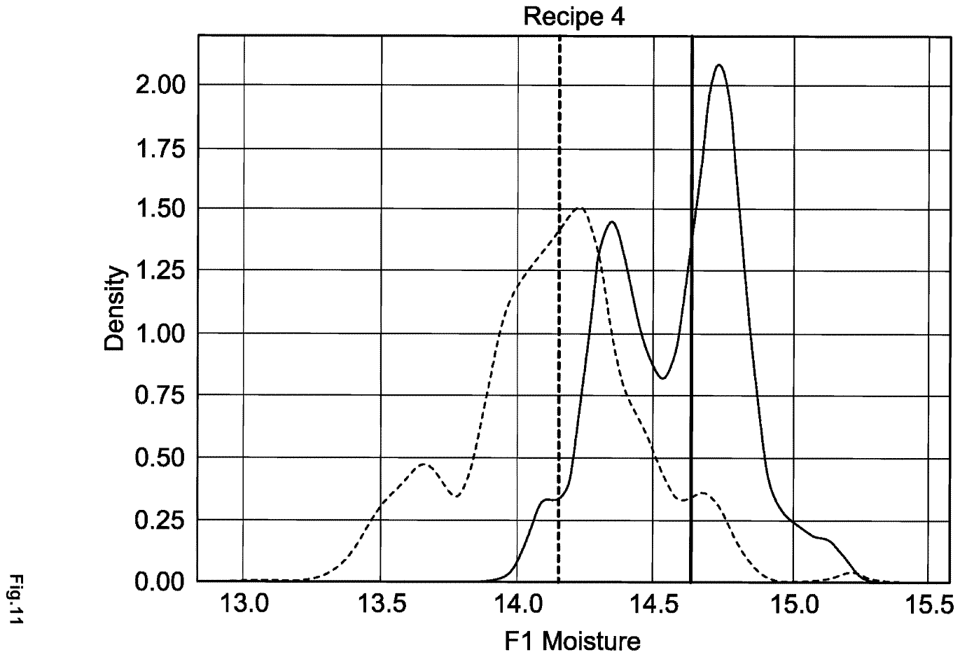

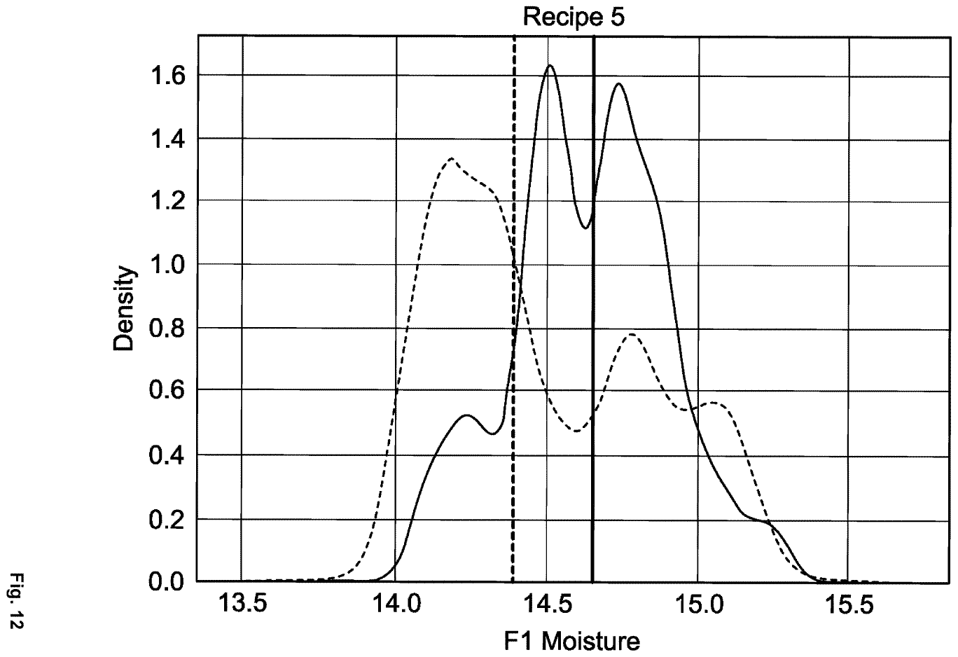

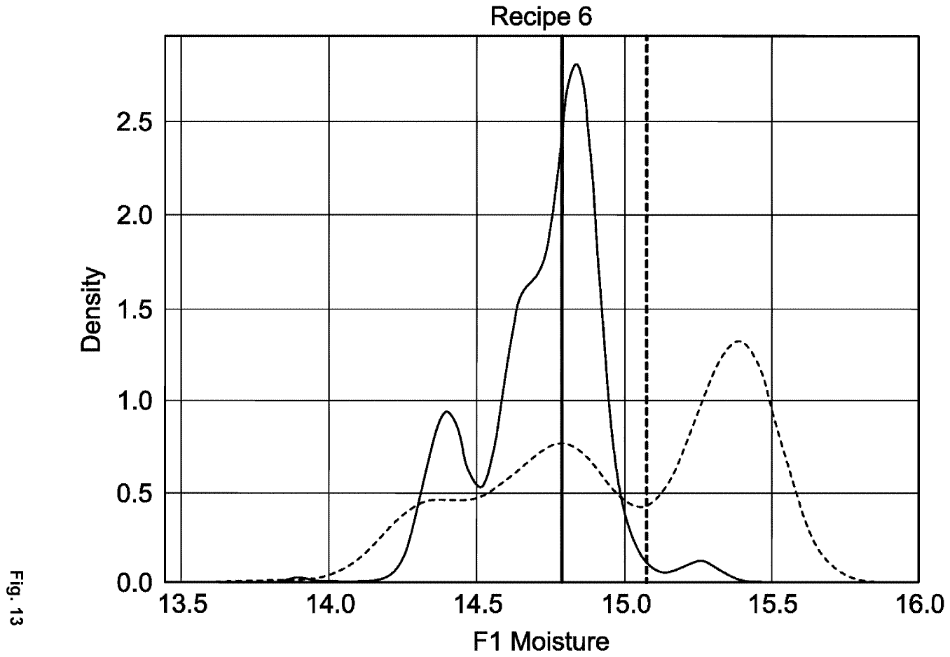

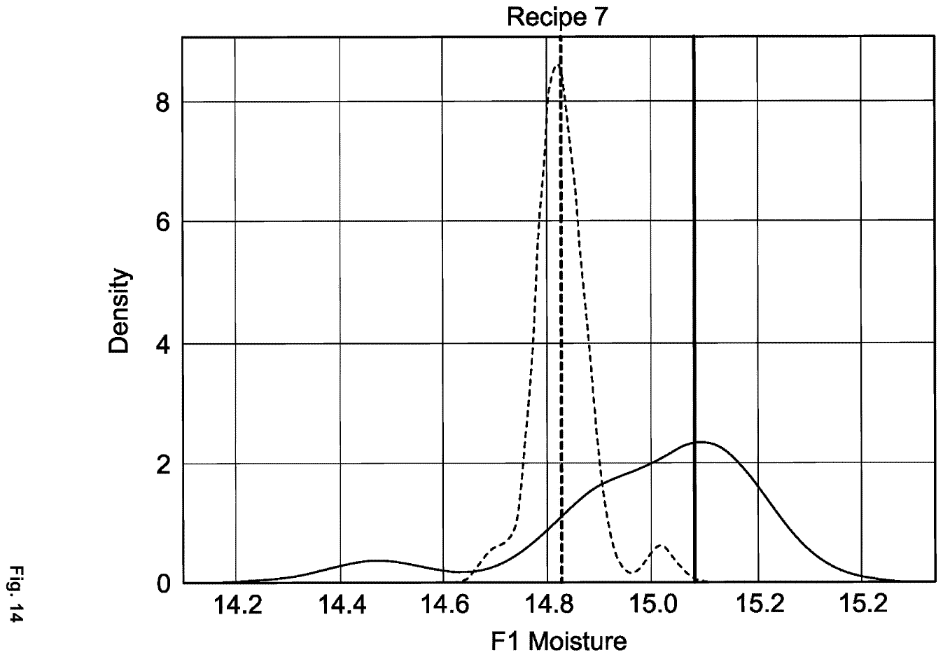

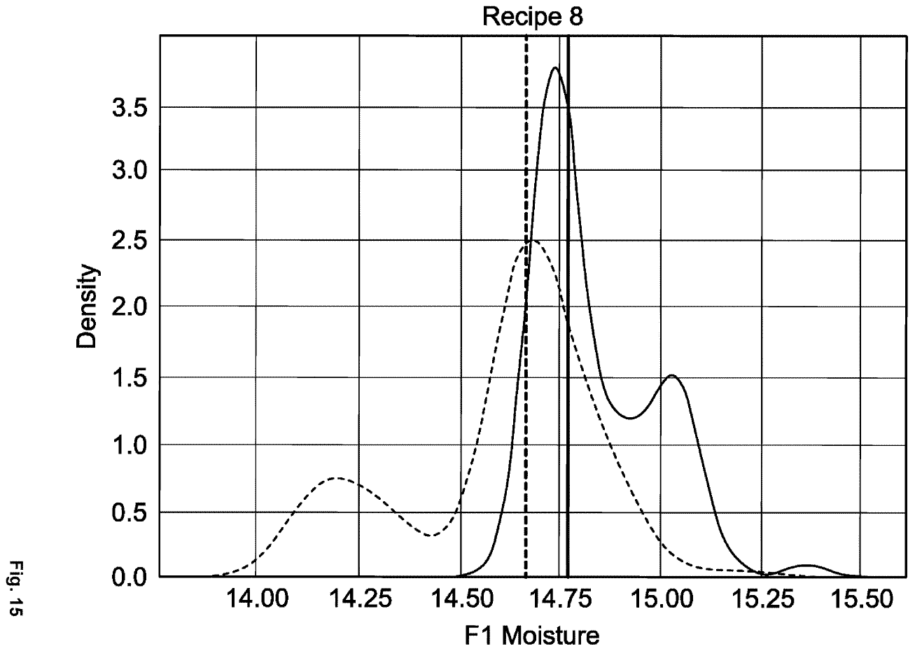

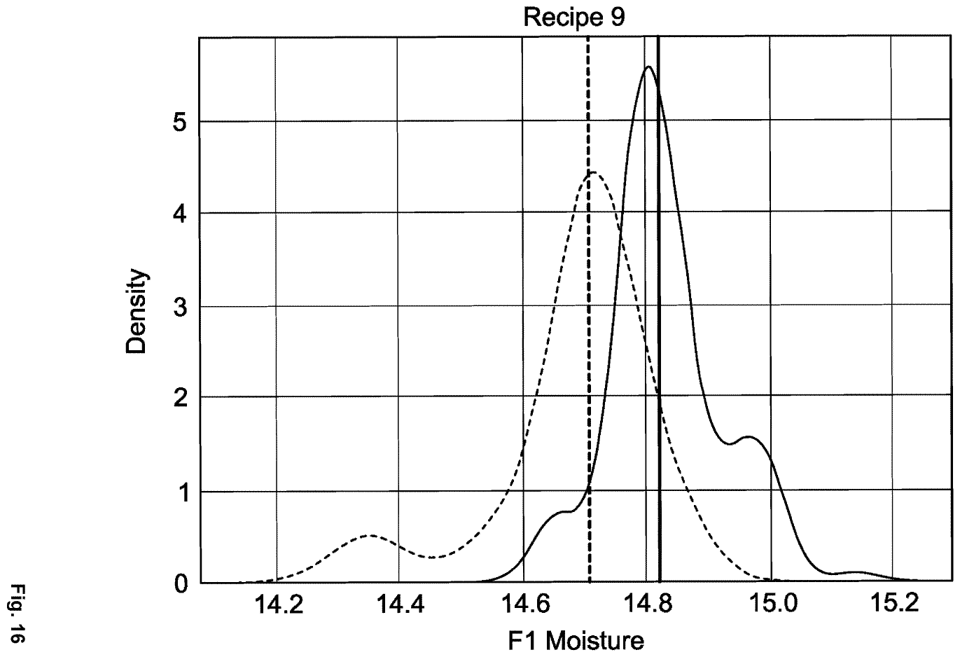

FIG. 11 shows a graph for recipe 4 with line curve that indicates actual moisture, and dotted line that indicates modelled moisture, with the optimal moisture for actual moisture seen at 14.6 and modeled moisture seen at around 14.15 for maximum flour yield. FIG. 12 shows a graph for recipe 5 with line curve that indicates actual moisture, and dotted line that indicates modelled moisture, with the optimal moisture for actual moisture seen at 14.65 and modeled moisture seen at around 14.4 for maximum flour yield. FIG. 13 shows a graph for recipe 6 having a line curve that indicates actual moisture, and dotted line that indicates modelled moisture, with the optimal moisture for actual moisture seen at 14.75 and modeled moisture seen at around 15.05 for maximum flour yield. FIG. 14 shows a graph for recipe 7 shows line curve that indicates actual moisture, and dotted line that indicates modelled moisture, with the optimal moisture for actual moisture seen at 15.1 and modeled moisture seen at around 14.82 for maximum flour yield. FIG. 15 shows a graph for recipe 8 that includes line curve that indicates actual moisture, and dotted line indicated modelled moisture, with the optimal moisture for actual moisture seen at 14.75 and modeled moisture seen at around 14.6 for maximum flour yield. FIG. 16 shows a graph for recipe 9 with a line curve that indicates actual moisture, and dotted line that indicates modelled moisture, with the optimal moisture for actual moisture seen at around 14.8 and modeled moisture seen at around 14.7 for maximum flour yield.

In some implementations, the digital model structure generated may be an artificial intelligence (AI) model structure that can operate automatically. The AI model structure may generate and deploy one or more policies as described above.

Advantages of such knowledge-based policies based on implementations disclosed in disclosure are that they are data-driven and transparent (as opposed to a black box machine learning algorithm), robust, and highly scalable due to their simplicity. In addition, maintenance and lifecycle effort of such implemented policies are relatively low due to their simplicity. Also using operational data to create a retrospective simulation of a flour milling machine 102, different optimization policy can then be back-tested on the simulation and benchmarked and a best policy can be selected before deployment in a real flour milling machine 102. The disclosure provides easy integration of control strategy (optimal policies) into a real-time automation system. Due to the use of simple and robust moisture control policies, and the policies not requiring machine learning techniques for execution, the solution can be easily scaled and deployed across flour milling setups across the world. As shown in the results of simulations and real world outputs, the disclosure has been able to consistently provide higher flour output and lower raw material usage. From the test results, the disclosure demonstrates an increased amount of extracted flour by up to 1.6% while maintaining quality specifications 1504. As a result, there is a positive global impact of reducing several million tons of carbon-di-oxide annually if deployed across the vast installed base of wheat mills. Furthermore, there is no additional cost overhead as there is no requirement for additional sensors for installation, as the disclosure can work with data provided from various commercial weather services. The disclosure provides a robust, data-driven optimization of the grain milling process to maximize commercial value for the flour producer and minimize raw material usage.

The process for implementing the disclosure, according to one embodiment is now described.

In step 1, a digital model structure may be generated that determines a relation of moisture with milling performance to generate a maximum yield from the flour milling machine 102. The digital model structure may be implemented in the first processing unit 104 or the second processing unit 110. One or more policies may be created by the operator and tested on the digital model structure, or one or more policies may be created by the digital model structure itself.

In step 2, an optimal policy from the one or more policies as a result of testing may be chosen and implemented in the first processing unit 104 or the second processing unit 110 or the controller 1025 of the flour milling machine 102.

In step 3, a target moisture may be calculated by executing the optimal policy for a given input of influence factors 150.

In step 4, the target moisture level is communicated by the first processing unit 104 or the second processing unit 110 to the water dosing controller 1024 of the water dosing unit 1023 through the controller 1025 via the machine interface 1042.

In step 5, the water dosing controller 1024 controls the moisture levels in the grain storage 1021 based on the target moisture level and feedback from the moisture sensor 1022.

In one implementation, the first processing unit 104 and the second processing unit 110 may be implemented as a device having a processor and a memory. As used herein, the term “processor” refers to a computational element that is operable to respond to and processes instructions that drive the system. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “processor” may refer to one or more individual processors, processing devices and various elements associated with a processing device that may be shared by other processing devices. Additionally, the one or more individual processors, processing devices and elements are arranged in various architectures for responding to and processing the instructions that drive the system.

The processor and accompanying components have connectivity to the memory via the bus. The memory includes both dynamic memory (e.g., RAM, magnetic disk, writable optical disk, etc.) and static memory (e.g., ROM, CD-ROM, etc.) for storing executable instructions that when executed perform the steps described herein for improving milling yield of a flour milling machine 102 to obtain optimized milling yield. The memory also stores the data associated with or generated by the execution of the inventive steps. Herein, the memory may be volatile memory and/or non-volatile memory. The memory may be coupled for communication with the processor. The processor may execute instructions and/or code stored in the memory. A variety of computer-readable storage media may be stored in and accessed from the memory. The memory may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

In another implementation, the first processing unit 104 and the second processing unit 110 may be implemented as a circuit or a specialized processing chip. In one or more implementations, the first processing unit 104 and the second processing unit 110 may be implemented or executed by one or multiple computing devices, which may be connected to a network (e.g., the internet or a local area network). Examples of digital processing units may include, but are not limited to, a digital computer devices, a laptop computer(s), mobile computing device(s), a server computer, a series of server computers, a mainframe computer(s), or a computing cloud(s).

In certain implementations, the first processing unit 104 and the second processing unit 110 may be physical or virtual devices. In many implementations, the processing unit may be any device capable of performing operations, such as a dedicated processor, a portion of a processor, a virtual processor, a portion of a virtual processor, a portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic.

In an example, the first processing unit 104 and the second processing unit 110 may be a computer-program product programmed for improving milling yield of a flour milling machine 102 to obtain optimized milling yield by generating a digital model structure. In another example, the processing unit may be a computer readable medium on which program code sections of a computer program are saved, the program code sections being loadable into and/or executable in a system to make the system execute the steps for performing the said purpose. The processing unit may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments, the processing unit can be implemented in a single chip.

In one embodiment, the processing unit includes a communication mechanism such as a bus for passing information among the components of the processing unit. The processing unit includes one or more processing units and a memory unit. Generally, the memory unit is communicatively coupled to the one or more processing units. Hereinafter, the one or more processing units are simply referred to as processor, and the memory unit is simply referred to as memory. Herein, in particular, the processor has connectivity to the bus to execute instructions and process information stored in the memory. The processor may include one or more processing cores with each core configured to perform independently. A multi-core processor enables multiprocessing within a single physical package. Examples of a multi-core processor include two, four, eight, or greater numbers of processing cores. Alternatively, or in addition, the processor may include one or more microprocessors configured in tandem via the bus to enable independent execution of instructions, pipelining, and multithreading. The processor may also be accompanied by one or more specialized components to perform certain processing functions and tasks such as one or more digital signal processors (DSP), or one or more application-specific integrated circuits (ASIC). A DSP typically is configured to process real-world signals (e.g., sound) in real time independently of the processor. Similarly, an ASIC can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

In one implementation, the modelling engine 1043 may be any logic circuitry that responds to and processes instructions fetched from the memory (not shown). In many embodiments, the modelling engine 1043 may be provided by a microprocessor unit, e.g., those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California. The modelling engine 1043 may utilize instruction-level parallelism, thread-level parallelism, different levels of cache, and multi-core processors. A multi-core processor may include two or more modelling engines on a single computing component. The memory (not shown) may include one or more memory chips capable of storing data and allowing any storage location to be directly accessed by the modelling engine 1043. The memory may be Dynamic Random-Access Memory (DRAM) or any variants, including static Random-Access Memory (SRAM), Enhanced DRAM (EDRAM), Single Data Rate Synchronous DRAM (SDR SDRAM), Double Data Rate SDRAM (DDR SDRAM), and Direct Rambus DRAM (DRDRAM). In some embodiments, the memory may be non-volatile; e.g., non-volatile read access memory (NVRAM), flash memory non-volatile static RAM (nvSRAM), or Ferroelectric RAM (FeRAM). The memory may be based on any of the above described memory chips, or any other available memory chips capable of operating as described herein.

Appropriate network connections can e.g., include a local area network (LAN) and a wide area network (WAN) but may also include other networks. When used in a LAN networking environment, the first processing unit 104, the second processing unit 110, the operations data storage 106, the data exchange repository 108 and the flour milling machine 102 can be connected to the network through a network interface. When used in a WAN networking environment, the first processing unit 104, the second processing unit 110, the operations data storage 106, the data exchange repository 108 and the flour milling machine 102 includes means for establishing communications over the WAN, such as the Internet. The existence of any of various well-known protocols such as TCP/IP, Ethernet, FTP, HTTP, and the like is presumed. Additionally, an application program used by the first processing unit 104, the second processing unit 110, the operations data storage 106, the data exchange repository 108 and the flour milling machine 102 according to an embodiment of the disclosure may include computer executable instructions for invoking functionality related to determining a safe route and displaying the safe route for the user.

In some implementations, the instruction sets and subroutines of, which may be stored on storage device, such as storage device coupled to computer, may be executed by one or more processors and one or more memory architectures included within computer. In some implementations, one or more of storage devices may include but are not limited to: hard disk drives; flash drives, tape drives; optical drives; RAID arrays; random access memories (RAM); and read-only memories (ROM). Examples of user devices (and/or computer) may include, but are not limited to, a personal computer, a laptop computer, a smart/data-enabled, cellular phone, a notebook computer, a tablet, a server, a television, a smart television, a media capturing device, and a dedicated network device.

While various embodiment variants of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

### REFERENCE LIST

1 Optimized flour milling system
   102 Flour milling machine
      1020 Flour milling machine setting
      1021 Persistence storage
      1022 Moisture sensor
      1023 Water dosing unit
         10231 Target moisture
         10232 Measured moisture of the grain
         10233 Grains dampening time
         10234 Moisture after conditioning of the grain
      1024 Water dosing controller
      1025 Electronic controller
      1026 Manufacturing execution system
   104 First processing unit
      1041 Input interface
      1042 Machine interface
      1043 Modelling engine
         10431 Digital representation
         10432 Digital model structure
   106 Operations data storage/persistence storage
      1061 Historical flour milling operation data
   108 Data exchange repository
   110 Second processing unit
   150 Flour milling operation data
      1501 Input grain/feed or supply material to be processed
         15011 Moisture of the grain material
         150111 Target Moisture of the grain material
         15012 Geographic origin of the grain (feed material)
         15013 Type of input grain (feed material to the mill)
         150131 Wheat
         Durum
         Rye
         Maize
         150135 Barley
         150136 Oats
         150137 Corn
         150138 Rice
         15014 Temperature of input grain (feed material to the mill)
         15014 Duration of conditioning of the grains
         150141 Moisture of the conditioned grains
      1502 Flour (processed/output material)
         15021 Types of flours produced (processed/output material)
         150211 All-Purpose Flour
         150211 Bread Flour
         150211 Whole Wheat Flour
         150211 White Whole Wheat Flour
         150211 Self-Rising Flour
         150211 Cake Flour
         150211 Pastry Flour
         150211 ‘00’ Flour etc.
         15022 Flour specification parameters
         150221 Flour quality specification
         1502211 Consistency
         1502212 Moisture content
         1502213 Protein content
         1502214 Ash content (indicator of extraction rate)
         1502215 Falling number, Sec.-enzymatic activity
         (→enzymatic corr.)
         1502216 Water absorption
         1502217 Granularity (particle size distribution)
         1502218 Wet gluten content
         1502219 Flour acidity etc.
   1503 Ambient and/or environmental conditions
      15031 Barometric pressure
      15032 Ambient air temperature
      15033 Atmospheric moisture etc.
   1504 Varying time lag
160 Yield
   1601 Average yield curve
   1602 Maximum yield for a given set of flour milling operation date
400 Plot
402 Average yield curve
500 Table

1. A milling system comprising:
at least one flour milling machine to provide a milling yield and to provide an optimized milling process for granular or grainy raw material to be processed to flour by the milling machine, the granular or grainy raw material at least includes grains or grain fruits of sweet grasses, the milling system including:
a flour milling machine including electronic control circuitry, a water doser;
an operations data storage to store historical flour milling machine operations data;
first processing circuitry coupled to the operations data storage, wherein
the first processing circuitry unit includes comprising:
a machine interface to receive the historical flour milling machine operations data from the operations data storage;
a machine-learning-based modelling engine to generate at least one digital model structure based on the historical flour milling operation data, the historical flour milling machine operations data at least include historical raw material, operational, or environmental characteristics parameter values of a flour milling machine, and the digital model structure is trained by applying the historical flour milling machine operation data as input values, wherein the historical raw material, operational, or environmental characteristics parameters at least include types of grains, temperature of the grains, moisture of the grains, duration of conditioning, moisture in conditioned grains, flour specifications, ambient conditions at the at least one flour milling machine, flour milling machine settings, types of flours produced from the grains, or yield of the at least one flour milling machine, and, after training, for determining for a given set of flour milling operations data the optimized milling yield as maximum yield using the at least one digital model structure by generating a target moisture for a given set of flour milling operation data using the at least one digital model structure for obtaining maximum flour yield, the target moisture is transmitted to the electronic control circuitry; and
the water doser includes water dosing control circuitry to receive the target moisture, and to adjust moisture to the grains based on the target moisture during production of the by the at least one flour milling machine.

2. The system according to claim 1, wherein the at least one digital model structure captures non-linear dependencies between the types of grains, temperature of the grains during milling, moisture in the grains dampening time to condition the grains, moisture in conditioned grains, flour specification parameters, ambient or environmental conditions at the at least one flour milling machine, flour milling machine settings, types of flours produced, and yield of the at least one flour milling machine and determine the target moisture to generate maximum yield using the at least one digital model structure.

3. The system according to claim 1, further comprising second processing circuitry, coupled to the first processing circuitry and the at least one flour milling machine, including:
a second machine interface to receive ambient or environmental conditions at the at least one flour milling machine from an input source, a type of grain and a value of moisture in the grains; and
third processing circuitry to execute the at least one digital model structure to generate an optimal control strategy to determine the target moisture based on the ambient or environmental conditions and the value of moisture in the grains.

4. The system according to claim 1, wherein the flour milling machine operations data includes types of grains, temperature of the grains during milling, moisture in raw grains, duration of conditioning to condition the grains, moisture in conditioned grains, flour consistency specifications, ambient conditions at the at least one flour milling machine, flour milling machine settings, types of flours produced from the grains, and yield of the at least one flour milling machine for the grains at different temperatures, different moisture levels, different dampening periods, different ambient conditions and different flour milling machine settings, wherein the flour milling machine settings include roller mill gaps, sifter sieve configuration, and roller wears.

5. The system according to claim 1, wherein the at least one flour milling machine includes manufacturing execution circuitry to enable adjustment of target moisture.

6. The system according to claim 1, wherein the system includes a data exchange repository coupled to the first processing circuitry and the at least one flour milling machine to exchange data associated with the operation of the at least one flour milling machine, log the data and store the at least one digital model structures.

7. The system according to claim 2, wherein the system includes a data exchange repository coupled to the first processing circuitry and the at least one flour milling machine to exchange data associated with the operation of the at least one flour milling machine, log the data and store the at least one digital model structure.

8. A method for improving milling yield of a flour milling machine to obtain optimized milling yield and raw material usage, comprising:
receiving, from an operation data storage, historical flour milling machine operations data;
generating, by a machine-learning-based modelling engine of first processing circuitry, at least one digital model structure to determine a target moisture based on the historical flour milling machine operations data using machine learning;
training the at least one digital model structure with training data to determine an influence of moisture levels among influencing factors on flour yield, wherein the influencing factors include types of grains, temperature of the grains, moisture in raw grains, duration of conditioning to condition the grains, moisture in conditioned grains, flour consistency specifications, ambient conditions at the flour milling machine, flour milling machine settings, types of flours produced from the grains, and yield of the flour milling machine and determine the target moisture to generate maximum yield using the at least one machine learning model structure, wherein the training data includes instances from the historical flour milling machine operations data having the influencing factors;
determining a target moisture for a given set of influencing factors using the at least one digital model structure for obtaining maximum flour yield;
communicating the target moisture to control circuitry; and
receiving, by water dosing control circuitry, the target moisture, and adding moisture to the grains based on the target moisture.

9. The system according to claim 1, wherein the at least one digital model structure captures non-linear dependencies between the types of grains, temperature of the grains during milling, moisture in the grains dampening time to condition the grains, moisture in conditioned grains, flour specification parameters, ambient or environmental conditions at the at least one flour milling machine, flour milling machine settings, types of flours produced, and yield of the at least one flour milling machine.

10. The system according to claim 1, further comprising second processing circuitry, coupled to the first processing circuitry and the at least one flour milling machine, including:
a second machine interface to receive ambient or environmental conditions at the at least one flour milling machine from an input source, a type of grain and a value of moisture in the grains.

11. The system according to claim 1, wherein the flour milling machine operations data includes types of grains, temperature of the grains during milling, moisture in raw grains, duration of conditioning to condition the grains, moisture in conditioned grains, flour consistency specifications, ambient conditions at the at least one flour milling machine, flour milling machine settings, types of flours produced from the grains, and yield of the at least one flour milling machine for the grains at different temperatures, different moisture levels, different dampening periods, different ambient conditions, and different flour milling machine settings.
